(19) United States
(12) Patent Application Publication
(10) Pub. No.: US 2024/0275198 A1
(43) Pub. Date: Aug. 15, 2024

(54) Energy Recovery in Electrical Systems

(71) Applicants: Steven Wesley DAVIS, Maple Valley, WA (US); David KIRTLEY, Seattle, WA (US); Christopher James PIHL, Woodinville, WA (US); James Melvin PIHL, Toronto (CA); Paul Nicholas RINALDI, Toronto (CA); Vito RINALDI, Stouffville (CA); Helion Energy, Inc., Everett, WA (US)

(72) Inventors: Steven Wesley Davis, Maple Valley, WA (US); David Kirtley, Seattle, WA (US); Christopher James Pihl, Woodinville, WA (US); James Melvin Pihl, Port Ludlow, WA (US); Paul Nicholas Rinaldi, Toronto (CA); Vito Rinaldi, Stouffville (CA)

(73) Assignee: Helion Energy, Inc., Everett, WA (US)

(21) Appl. No.: 18/566,955

(22) PCT Filed: Jun. 3, 2022
(86) PCT No.: PCT/US2022/032277

§ 371 Date: Dec. 4, 2023

Related U.S. Application Data
(60) Provisional application No. 63/196,469, filed on Jun. 3, 2021.

(51) Int. Cl. H02J 7/00; H02J 7/34

(52) U.S. Cl. CPC H02J 7/0063; H02J 7/00711; H02J 7/345; H02J 2207/50

(57) ABSTRACT

Energy-recovery systems and methods are described that can recover excess energy remaining in an electrical or electromagnetic system after the system performs a function during each operational cycle of the system. The recovered energy can be made available for the start of the next operational cycle. The energy-recovery circuits are suitable for high voltage and/or high current pulsed-power applications.

### CROSS-REFERENCE TO RELATED APPLICATIONS

The present application claims a priority benefit, under 35 U.S.C. § 119(e), to U.S. provisional application Ser. No. 63/196,469 filed on Jun. 3, 2021, titled “Energy Recovery in Electrical Systems,” which application is incorporated herein by reference in its entirety.

### BACKGROUND

Some electrical, electromagnetic, and electromechanical systems may drive currents through inductive, resistive, and/or capacitive loads to perform some function, which may be, for example, to create an electric field, convert electrical energy into mechanical energy, and/or to create a magnetic field. In some cases, the current may be applied as a cyclical waveform, repeating the application of current every cycle. After the function is performed, there can be a significant amount of energy remaining in the load or other circuitry connected to the load (e.g., stored in inductors and/or capacitors) which may be dissipated and lost before the next cycle occurs. Example apparatus in which such energy loss can occur includes electromagnetic forming and magnetic swaging apparatus, rail guns, and apparatus to confine and/or accelerate plasmas, ions, or atomic particles.

### SUMMARY

The described implementations relate to energy-recovery in electrical systems that may include loads with energy-storage components such as capacitors and/or inductors. The electrical systems may operate with repeated cycles to perform a function repetitively. Each cycle can include multiple operational states that the electrical system attains during portions of the cycle. For example, a cycle can begin with the electrical system placed in a first state where at least one component in the electrical system energized, pass through one or more additional states during which energy from the component(s) is delivered to a load and a function is performed, placed in one or more states to recover energy from the load, and then end with the system in a final state for the cycle. The system may then proceed from the final state to the first state at the start of the next cycle, wherein the recovered energy can be made available for application to the load during the next cycle. In this regard, recovery of energy from the system during each operational cycle constitutes recycling of system energy that, without the energy-recovery circuitry described herein, would be lost or wasted.

The electrical systems described herein can include circuits with energy-recovery circuit paths that can receive energy from the load after performance of a system function back to an energy-storage component for a next operational cycle of the system. In this way the recovered energy can be used again for the subsequent performance of the system's function(s) and a total amount of energy consumed by the system can be significantly less than if the energy were not recovered for a next cycle and dissipated instead. In some cases, the amount of energy recovered can be over 90% of the energy applied to the load in a previous cycle.

In some cases, energy received from the load during each cycle can be harvested for external use. For example, a function performed by the load may be generating energy. Excess energy produced with each cycle may be tapped off for external use.

Some circuit applications can involve high peak currents (e.g., over 10⁶ amps) and/or high peak voltages (e.g., over 10³ volts). Further, these circuit applications may operate in pulsed mode with fast switching and a short pulse of current for each cycle. For example, the pulse duration can have a full-width half-maximum value between 1 microsecond and 500 microseconds according to some implementations. In some cases, the pulse durations can be shorter than 1 microsecond. In some cases, the pulse durations can be longer than 500 microseconds. The peak power for such pulse durations can be up to or exceed 1 gigawatt in some cases. The circuits described herein are suitable to handle such pulsed, high-power systems.

An aspect of the circuits described herein are directional switches that can switch such high currents and voltages. The directional switching circuits comprise one or more switching elements (such as silicon-controlled rectifiers) in series with one or more forward diodes. The diodes can absorb most of the recovery energy that is imposed on the directional switch when the switch goes into a blocking mode. Because of the forward diodes, the switching elements can be operated at power levels that would otherwise exceed their operating limits.

Some implementations relate to circuits to deliver energy to a load in repeated cycles and recover a portion of the energy. Such circuits can comprise an energy-storage component to receive energy from a voltage source or current source and a first switch to reversibly couple the energy-storage component to a load along a first circuit path, the first switch configured to attain a first state such that, when the first switch is in the first state during a first portion of a first cycle of the repeated cycles, forward current flows from the energy-storage component to the load. Such circuits can further include a second switch to reversibly couple the energy-storage component to the load along a second circuit path, wherein the second circuit path is different, at least in part, from the first circuit path, the second switch configured to attain a first state such that, when the second switch is in the first state of the second switch during a second portion of the first cycle, energy from the load is returned to the energy-storage component such that at least a portion of the energy returned is available for a first portion of a second cycle of the repeated cycles that follows the first cycle.

Some implementations relate to methods of recovering energy from a load in a system that operates with repeated cycles. Such methods can include acts of: storing a first amount of energy in a first energy-storage component of a circuit; delivering, during a first portion of the first cycle of repeated cycles, at least a portion of the first amount of energy from the first energy-storage component to the load along a first circuit path of the circuit, wherein the load includes a second energy-storage component; and returning, during a second portion of the first cycle, a second amount of energy from the second energy-storage component along a second circuit path of the circuit to the first energy-storage component so that at least a portion of the returned second amount of energy is available for a first portion of a second cycle of the repeated cycles that follows the first cycle, wherein the second circuit path is different, at least in part, from the first circuit path.

Some implementations relate to methods of assembling a circuit to recover energy from a load in a system that operates with repeated cycles. Such methods can include acts of: arranging a first switch in a first circuit path to reversibly couple an energy-storage component to a load during a first portion of a first cycle of the repeated cycles, such that when the first switch is in a first state during the first portion of the first cycle, the energy-storage component delivers energy to the load along the first circuit path during the first portion of the first cycle; and arranging a second switch in a second circuit path that is different, at least in part, from the first circuit path to reversibly couple the load to the energy-storage component along the second path during a second portion of the first cycle, such that when the second switch is in a first state of the second switch during the second portion of the first cycle, energy is returned from the load to the energy-storage component during the second portion of the first cycle and made available for a first portion of a second cycle of the repeated cycles that follows the first cycle.

Some implementations relate to systems for recovering electromagnetic energy in a circuit. Such systems can comprise a first energy-storage component, a second energy-storage component, a load, and a first switch to reversibly couple the first energy-storage component and the second energy-storage component to the load along a first circuit path during a first portion of an operational cycle of the system such that current flows from the first energy-storage component to the second energy-storage component and to the load. Such systems can further include a second circuit path different, at least in part, from the first circuit path and having a second switch to reversibly couple the load to the first energy-storage component during a second portion of the operational cycle, the second circuit path configured to return energy from the load to the first energy-storage component so that the returned energy is available for a start of a next operational cycle of the system and a voltage polarity across the first energy-storage component at the end of the second portion of the operational cycle is a same voltage polarity as the voltage polarity across the first energy-storage component at the beginning of the first portion of the operational cycle.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1A depicts a circuit for an electrical system that performs energy recovery and operates with repeated cycles.

FIG. 1B depicts a series of operational states for the circuit of FIG. 1A.

FIG. 1C depicts an example voltage waveform on the energy-storage component C1 for the states S1 through S6 described in connection with FIG. 1B.

FIG. 1D depicts an example current waveform applied to the load for the states S1 through S6 described in connection with FIG. 1B.

FIG. 1E is a simplified model of the energy-recovery circuit of FIG. 1A.

FIG. 2A depicts a circuit for an electrical system that performs energy recovery and operates with repeated cycles.

FIG. 2B depicts simulated voltage waveforms for the circuit of FIG. 2A.

FIG. 2C depicts simulated current waveforms for the circuit of FIG. 2A.

FIG. 2D depicts a simplified model and variation of the energy-recovery circuit of FIG. 2A.

FIG. 2E depicts a simulated voltage waveform for the circuit of FIG. 2D.

FIG. 2F depicts simulated current waveforms for the circuit of FIG. 2D.

FIG. 3A depicts a circuit for an electrical system that performs energy recovery and operates with repeated cycles.

FIG. 3B depicts simulated voltage waveforms for the circuit of FIG. 3A.

FIG. 3C depicts simulated current waveforms for the circuit of FIG. 3A.

FIG. 4A depicts a circuit for an electrical system that performs energy recovery and operates with repeated cycles.

FIG. 4B depicts a series of operational states for the circuit of FIG. 4A.

FIG. 4C depicts an example voltage waveform on the energy-storage component C1 for the states S1 through S6 described in connection with FIG. 4B.

FIG. 4D depicts an example current waveform applied to the load for the states S1 through S6 described in connection with FIG. 4B.

FIG. 4E depicts an example current waveform applied to the load for the states S1 through S6 described in connection with FIG. 4B with different inductance values than those used for FIG. 4C and FIG. 4D.

FIG. 5A depicts a circuit for an electrical system that performs energy recovery and operates with repeated cycles.

FIG. 5B depicts simulated voltage waveforms for the circuit of FIG. 5A.

FIG. 5C depicts simulated current waveforms for the circuit of FIG. 5A.

FIG. 5D depicts a simplified model and variation of the energy-recovery circuit of FIG. 5A.

FIG. 5E depicts simulated voltage waveforms for the circuit of FIG. 5D.

FIG. 5F depicts simulated current waveforms for the circuit of FIG. 5D.

FIG. 6A depicts a circuit for an electrical system that performs energy recovery and operates with repeated cycles.

FIG. 6B depicts simulated voltage waveforms for the circuit of FIG. 6A.

FIG. 6C depicts simulated current waveforms for the circuit of FIG. 6A.

FIG. 7A depicts a circuit for an electrical system that performs energy recovery and operates with repeated cycles.

FIG. 7B depicts simulated voltage waveforms for the circuit of FIG. 7A.

FIG. 7C depicts simulated current waveforms for the circuit of FIG. 7A.

FIG. 7D depicts a simplified model and variation of the energy-recovery circuit of FIG. 7A.

FIG. 7E depicts simulated voltage waveforms for the circuit of FIG. 7D.

FIG. 7F depicts simulated current waveforms for the circuit of FIG. 7D.

FIG. 8A depicts a circuit for an electrical system that performs energy recovery and operates with repeated cycles.

FIG. 8B depicts simulated voltage waveforms for the circuit of FIG. 8A.

FIG. 8C depicts simulated current waveforms for the circuit of FIG. 8A.

FIG. 8D depicts a simplified model and variation of the energy-recovery circuit of FIG. 8A.

FIG. 8E depicts simulated voltage waveforms for the circuit of FIG. 8D.

FIG. 8F depicts simulated current waveforms for the circuit of FIG. 8D.

FIG. 8G depicts a simplified model and variation of the energy-recovery circuit of FIG. 8A.

FIG. 8H depicts simulated voltage waveforms for the circuit of FIG. 8G.

FIG. 8I depicts simulated current waveforms for the circuit of FIG. 8G.

FIG. 9A depicts a circuit for an electrical system that performs energy recovery and operates with repeated cycles.

FIG. 9B depicts simulated voltage waveforms for the circuit of FIG. 9A.

FIG. 9C depicts simulated current waveforms for the circuit of FIG. 9A.

FIG. 10A depicts a circuit for an electrical system that performs energy recovery and operates with repeated cycles.

FIG. 10B depicts simulated current waveforms for the circuit of FIG. 10A.

FIG. 10C depicts simulated current waveforms for the circuit of FIG. 10A.

FIG. 10D depicts a simplified model of the energy-recovery circuit of FIG. 10A.

FIG. 10E depicts a stacked variation of the circuit of FIG. 10D.

FIG. 11A depicts a circuit for an electrical system that performs energy recovery and operates with repeated cycles.

FIG. 11B depicts simulated voltage waveforms for the circuit of FIG. 11A.

FIG. 11C depicts simulated voltage waveforms for the circuit of FIG. 11A.

FIG. 12A depicts a circuit for an electrical system that performs energy recovery and operates with repeated cycles.

FIG. 12B depicts simulated voltage waveforms for the circuit of FIG. 12A.

FIG. 12C depicts simulated current waveforms for the circuit of FIG. 12A.

FIG. 12D depicts a simplified model of the energy-recovery circuit of FIG. 12A.

FIG. 12E depicts simulated voltage waveforms for the circuit of FIG. 12D.

FIG. 12F depicts simulated current waveforms for the circuit of FIG. 12D.

FIG. 13A depicts a circuit for an electrical system that performs energy recovery and operates with repeated cycles.

FIG. 13B depicts simulated voltage waveforms for the circuit of FIG. 13A.

FIG. 13C depicts simulated current waveforms for the circuit of FIG. 13A.

FIG. 14A depicts a circuit for an electrical system that performs energy recovery and operates with repeated cycles.

FIG. 14B depicts simulated voltage waveforms for the circuit of FIG. 14A.

FIG. 14C depicts simulated current waveforms for the circuit of FIG. 14A.

FIG. 14D depicts a simplified model of the energy-recovery circuit of FIG. 14A.

FIG. 14E depicts simulated voltage waveforms for the circuit of FIG. 14D.

FIG. 14F depicts simulated current waveforms for the circuit of FIG. 14D.

FIG. 15A depicts a circuit for an electrical system that performs energy recovery and operates with repeated cycles.

FIG. 15B depicts simulated voltage waveforms for the circuit of FIG. 15A.

FIG. 15C depicts simulated current waveforms for the circuit of FIG. 15A.

FIG. 16A depicts a circuit for an electrical system that performs energy recovery and operates with repeated cycles.

FIG. 16B depicts simulated voltage waveforms for the circuit of FIG. 16A.

FIG. 16C depicts simulated current waveforms for the circuit of FIG. 16A.

FIG. 17A depicts a schematic for a directional switch that includes a plurality of SCRs connected in series.

FIG. 17B depicts a schematic for a directional switch that includes a plurality of SCRs connected in series.

FIG. 17C depicts a schematic for a directional switch that includes a plurality of SCRs connected in series and in parallel.

FIG. 17D depicts a schematic for a directional switch that includes a SCR connected in series with a diode.

FIG. 17E depicts a schematic for a directional switch that includes a SCR connected in series with a forward diode and in parallel with a reverse diode.

FIG. 17F depicts a schematic for a bidirectional switch.

FIG. 18A depicts a circuit for an electrical system that can deliver energy to portions of a load.

FIG. 18B depicts simulated voltage waveforms for the circuit of FIG. 18A.

FIG. 18C depicts simulated current waveforms for the circuit of FIG. 18A.

FIG. 19A depicts a circuit for an electrical system that can deliver energy to a load at two different rates.

FIG. 19B depicts simulated voltage waveforms for the circuit of FIG. 19A.

FIG. 19C depicts simulated current waveforms for the circuit of FIG. 19A. FIG. 19D depicts a simplified model of the circuit of FIG. 19A.

FIG. 19E depicts a simplified model and variation of the circuit of FIG. 19A.

FIG. 20A depicts a circuit for an electrical system that performs energy recovery and operates with repeated cycles. The circuit can hold current flow through the load for a desired interval of time.

FIG. 20B depicts simulated voltage waveforms for the circuit of FIG. 20A.

FIG. 20C depicts simulated current waveforms for the circuit of FIG. 20A.

FIG. 21 depicts a circuit for an electrical system that performs energy recovery and operates with repeated cycles. The circuit combines several features of voltage inversion on the energy-storage component, current holding, and pulse shaping.

FIG. 22A depicts a circuit for an electrical system that performs energy recovery and operates with repeated cycles. The circuit combines several features of voltage inversion on the energy-storage component and pulse shaping.

FIG. 22B depicts simulated voltage waveforms for the circuit of FIG. 22A.

FIG. 22C depicts simulated current waveforms for the circuit of FIG. 22A.

### DETAILED DESCRIPTION

### 1. Introduction to Energy Recovery Systems

It is typical for conventional pulsed or cyclic electrical systems with inductive components (such as particle accelerators) to waste unutilized energy that is delivered to the inductive components to perform some operation by the system (e.g., accelerate the particles). Often, the unutilized energy is wasted in the form of heat. This waste of energy can increase operational costs and energy consumption and can slow the rate at which the system can do useful work.

The inventors have recognized and appreciated that energy recovery in pulsed or cyclic electrical systems can be highly beneficial. Efficient energy recovery can reduce system operating costs, particularly in high-power systems. In systems where heat is generated from wasted, unrecovered energy, implementing energy recovery can also allow operation at higher repetition rates (e.g., by reducing cooling needs and/or reducing the amount of input energy needed from a supply per cycle), which can result in higher system productivity.

The inventors have further recognized and appreciated that challenges arise when working with pulsed systems that involve switching of high currents (e.g., over 10⁶ amps) and/or high voltages (e.g., over 10³ volts) as well as tailored pulse shapes. The inventors have further realized that additional challenges arise when the switching of current has to occur over a very short time scale (e.g., hundreds of microseconds or less). The challenges in such system relate to designing switches that can withstand the high currents, heat, and/or voltage bias imposed on the switches during operation as well as designing circuits that can use electrical components efficiently and yet protect the components from harm. Some pulsed power applications that could benefit from energy-recovery technology described below include, but are not limited to, electromagnetic forming and magnetic swaging apparatus, rail guns, and apparatus to confine and/or accelerate plasmas, ions, or atomic particles.

### 2. Example Energy-Recovery Circuits

### 2.1 Overview of Energy-Recovery Circuits

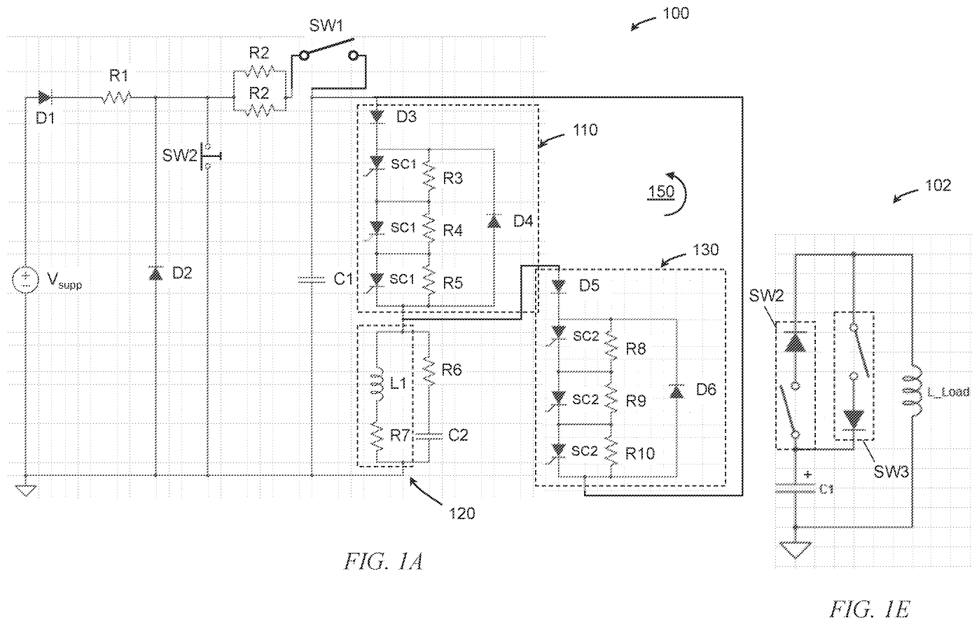

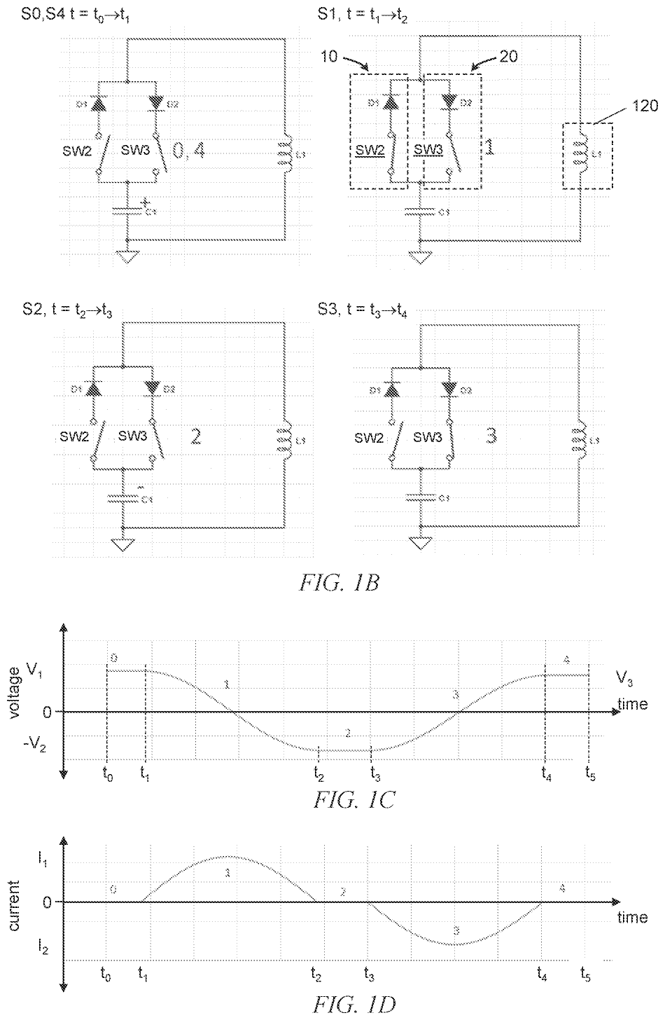

FIG. 1A through FIG. 16A and FIG. 20A through FIG. 21 depict different examples of circuits for an electrical system that can perform energy recovery and operate with repeated cycles. The circuits can be adapted for operating with high currents and/or high voltages as well as switch at high speeds. For the illustrative circuits, the load is depicted as an inductor (L1). In a practical implementation, the load can be some device that has inductance (e.g., a magnetic coil used to produce intense magnetic fields). In some cases, the load may also have, or consist of, capacitance and/or resistance. In some implementations, the load may have some combination of inductance, capacitance, and resistance.

The illustrative circuits also include at least one energy-storage component (capacitor(s) for the depicted circuits) from which energy is delivered to the load and/or into which energy is recovered from the load. In a high-power application, each energy-storage component may be a bank of capacitors to store large amounts of energy. In some implementations, an energy-storage component can include inductance and/or resistance. When the load is primarily capacitive, the energy-storage component can be primarily inductive. In some cases, the energy-storage component can be an electromagnetic generator or motor coupled to a flywheel where electromagnetic energy can be converted to mechanical energy stored in the flywheel and then converted back to electromagnetic energy from the spinning flywheel.

For some of the circuits, the same energy-storage component is used to deliver energy to the load and recover energy from the load. In some circuits, the polarity of voltage on the energy-storage component reverses when the system transitions from energy delivery to energy recovery. Although this may eliminate an additional and separate energy-storage component for energy recovery, it can place a higher technical demand on the single energy-storage component when operating at high voltages and currents. Namely, the energy-storage component should be designed to handle such high voltages and currents in both forward and reverse modes. Some energy-storage components (such as electrolytic capacitors) would not be able to operate under such conditions. Accordingly, aspects disclosed herein encompass some circuits for which the polarity of voltage on the energy-storage component(s) is (are) not reversed.

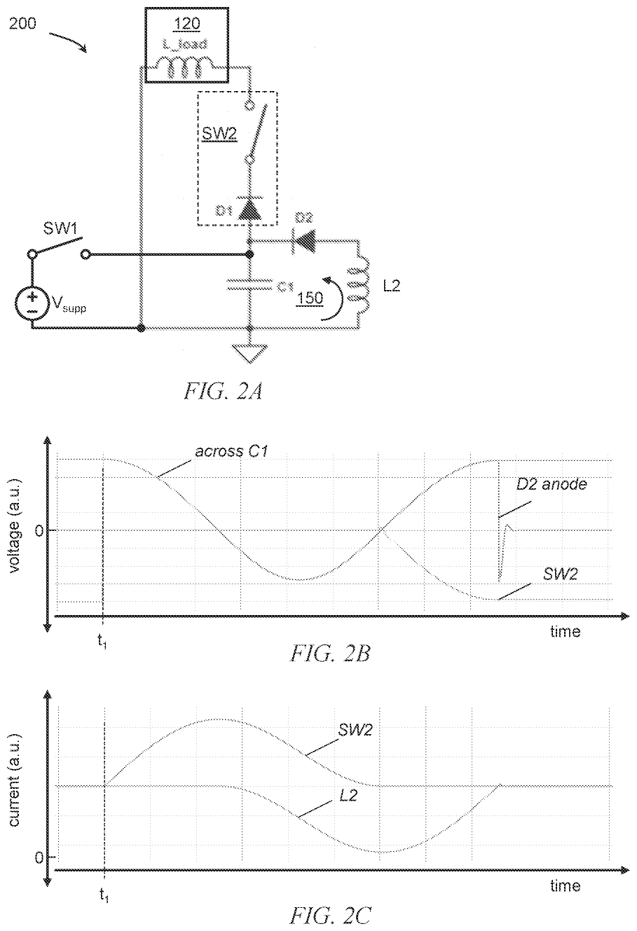

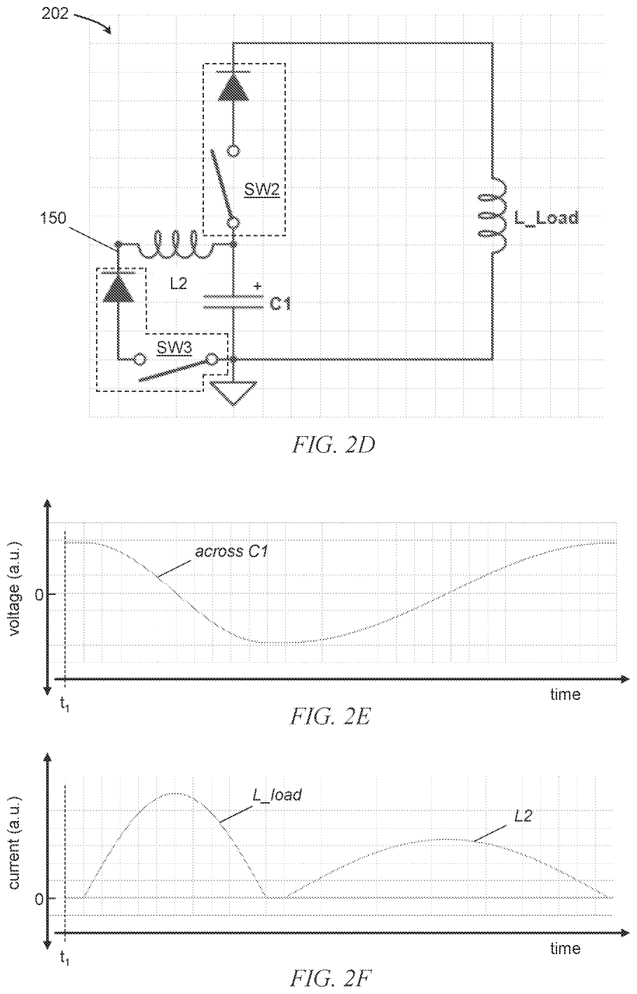

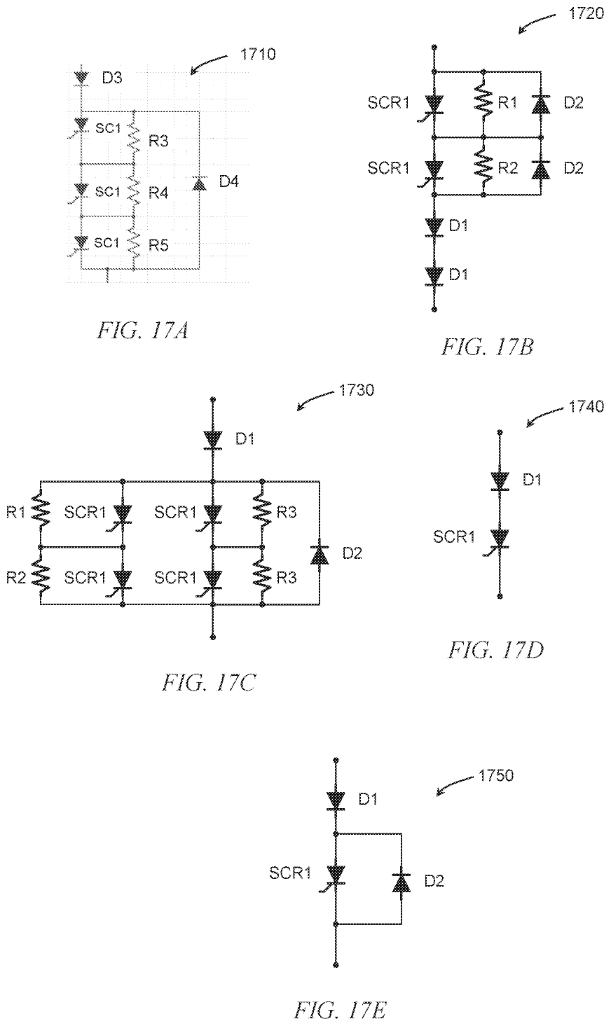

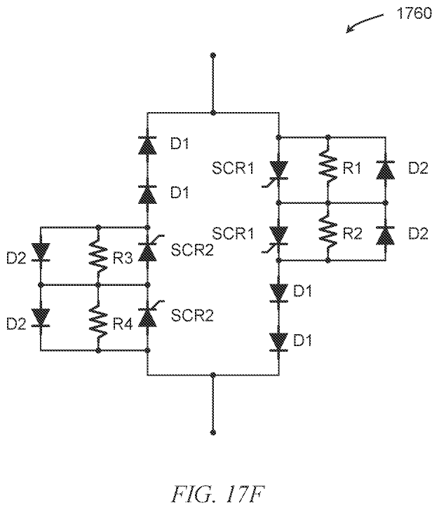

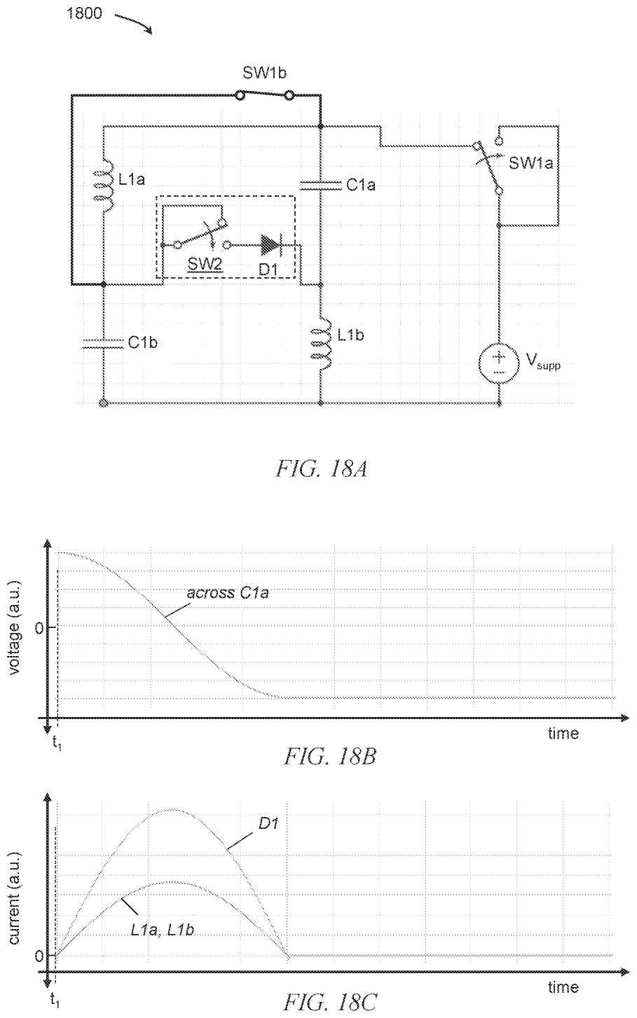

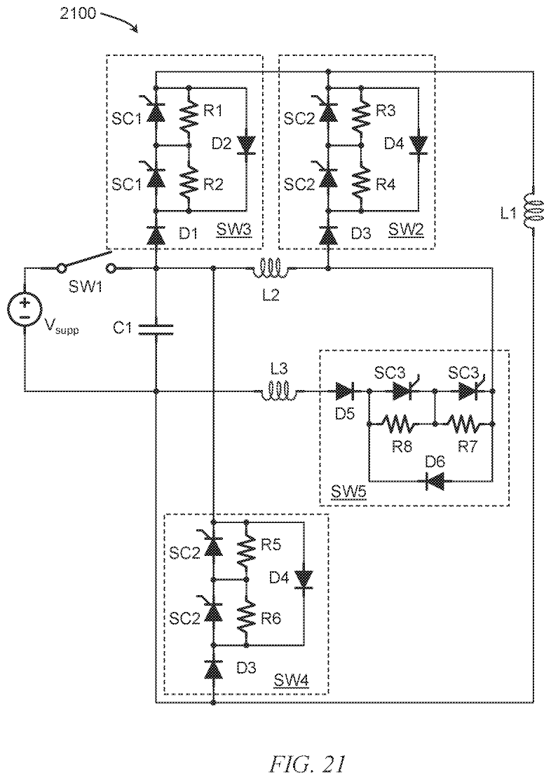

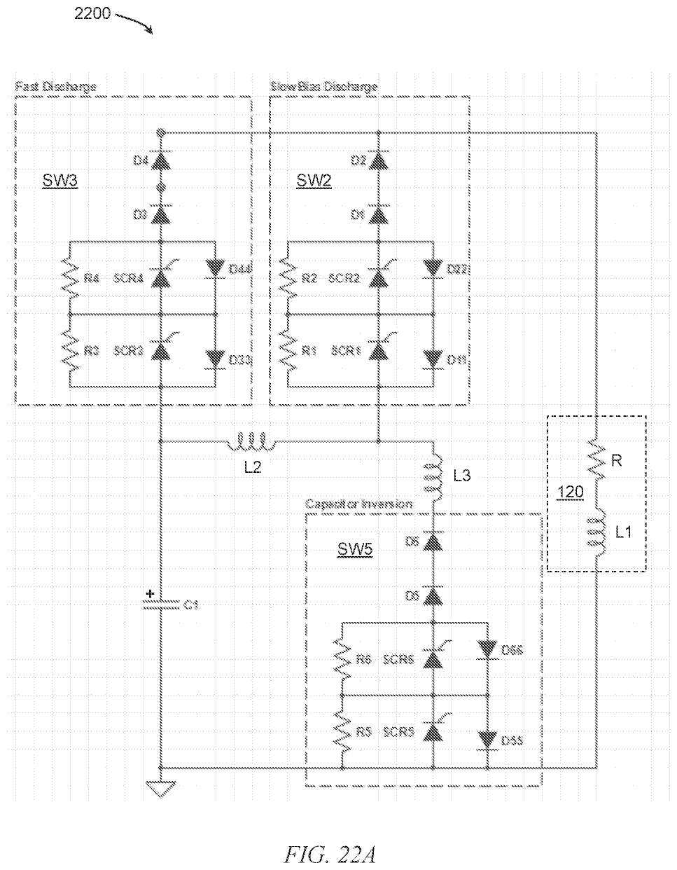

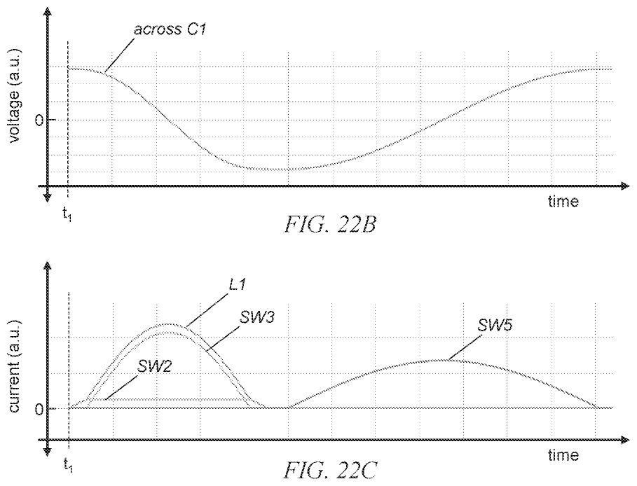

Circuit arrangements shown below enable energy recovery in low and high energy applications, and in slow and high-speed switching applications, while addressing the challenges described above. A first example of an energy-recovery circuit is described in detail in connection with FIG. 1A that includes aspects shared by the energy-recovery circuits that follow in FIG. 2A through FIG. 16A. FIG. 17A through FIG. 17F and their related discussions describe example switching circuits that can be used in the energy-recovery circuits. FIG. 18A through FIG. 20A depict example subcircuits that can be used in the energy-recovery circuits to perform certain functions during an operational cycle of the energy-recovery circuits. Such functions can include rapid delivery of energy to portions of a load where the supply voltage is multiplied by a factor (2 in the example of FIG. 18) across the load, pulse shaping, and generation of a flat-top current pulse. FIG. 21, FIG. 22A, and their related discussions pertain to energy-recovery circuits that have different combinations of the sub-circuits and switching circuits.

In some implementations, the circuits of FIG. 1A through FIG. 16A and FIG. 20A through FIG. 21 can be used to drive large currents through a single-turn or segmented electromagnetic coil (indicated as L1 or L_load) to create intense magnetic fields. For example, the amount of current in a pulse can have a peak value in a range from 100,000 amps (A) to 200,000,000 A, or any sub-range within this range (e.g., from 500,000 A to 200,000,000 A). Higher or lower current values may be used in some cases. The peak magnetic field that can be produced can have a value in a range from 0.1 Tesla (T) to 50 T, or any sub-range within this range. Higher or lower magnetic fields may be produced in some cases. Examples of single-turn and segmented electromagnetic coils can be found in U.S. Patent Application No. 63/210,416 titled, “Inertially-Damped Segmented Coils for Generating High Magnetic Fields” and filed on Jun. 14, 2021, the entire disclosure of which is incorporated by reference. The energy-recovery circuits described below can be capable of operating for up to 10,000 cycles without servicing or replacement of circuit components, though the load may need servicing or replacement in fewer cycles.

### 2.2 Details of Different Types of Energy-Recovery Circuits

This section describes a number of different circuits depicted in FIG. 1A through FIG. 16A that can be used in a system to recover energy from a load. The energy can be provided to the load with a pulse of current for each cycle of system operation, for example. The circuits below can recover a portion of the energy provided to the load in each cycle. The type of circuit used for energy recovery may depend upon the particular application. In this regard, some of the energy-recovery circuits described below may be advantageous over other energy-recovery circuits described below for the particular application in which the circuit will be used.

### 2.2a Description of a Sample Energy-Recovery Circuit

FIG. 1A depicts a schematic of an energy-recovery system 100 that can perform energy recovery and operate with repeated cycles. The system 100 can be partitioned into supply circuitry which includes switch SW1 and components to the left of energy-storage component C1 in the drawing, a load 120, and energy-recovery circuitry which includes a first directional switch 110, energy-storage component C1, a second directional switch 130, and a snubber circuit (comprising resistor R6 and capacitor C2) for the illustrated implementation.

The system's supply circuitry can include a supply Vₛᵤₚₚ (which can be a voltage or current supply) that is arranged with the switch SW1 or otherwise controlled to charge the energy-storage component C1 to the supply voltage and then disconnect or isolate from the energy-recovery circuitry. The energy-storage component can be one or more energy-storage components, such as a capacitor or bank of capacitors. There can be one or more circuit components connected between the supply Vₛᵤₚₚ and the energy-storage component C1. In the illustrated example, a diode D1, first resistor R1, and parallel connected resistors R2 connect in series between the supply Vₛᵤₚₚ and the energy-storage component C1. These components can be selected to determine an energy delivery rate to the energy-storage component C1. Diode D1 can block reverse voltages and essentially all reverse current during operation of the system that would otherwise flow back to the supply Vₛᵤₚₚ potentially harming the supply. A switch SW2 may or may not be included to function as a crowbar or kill switch that is used as an emergency shutdown of the system. Diode D2 can protect the charging circuit from transient spikes that may occur when switch SW1 or switch SW2 opens and closes.

The supply circuitry of FIG. 1A is one example of supply circuitry that can be used to charge the energy-storage component C1. The invention is not limited to only the illustrated supply circuitry. Other circuit configurations are possible for the supply circuitry.

The energy-storage component C1 can connect (reversibly couple) to a load 120 through the first directional switching circuit 110 (forward direction). The forward direction is the direction of energy flow through the load 120 when the energy is initially delivered to the load from the energy-storage component C1 after being charged. The reverse direction is an oppositely directed flow of current back through the load 120. The energy-storage component can also reversibly couple to the load 120 with the second directional switching circuit 130 (reverse direction). The load can be any type of component or device that draws a large amount of current. As one example, the load is an electromagnetic coil that is used to produce an intense magnetic field (e.g., over 0.1 Tesla). Such a load can be modeled as an inductor L1 in series with a first resistor R7, though it is understood that the load can have any suitable configuration as described herein.

The forward directional switching circuit 110 can include one or more switching elements SC1 (e.g., silicon-controlled rectifiers (SCRs) in the illustrated circuit) connected in series with a forward diode D3. Although depicted as a single diode, the forward diode D3 can comprise multiple diodes connected in series. Additionally or alternatively, the forward diode D3 can comprise multiple diodes connected in parallel. Other types of switching elements (such as controlled insulated gate bipolar transistors (IGBTs), power field-effect transistors (power FETs), junction field-effect transistors (JFETs), etc.) can be used in other implementations instead of SCRs. A desirable feature of SCRs is that they can be self-commutating, turning off automatically when the forward current through the SCR drops below its holding current. For some implementations, at least one SCR in a switching circuit can be triggered by a control signal applied to the SCR's gate terminal to initiate the flow of current between the device's cathode and anode.

When multiple switching elements are used for a directional switching circuit 110, 130, balancing resistors R3, R4, R5 (which may or may not have a same resistance value) as illustrated herein can be employed to establish selected voltage drops across the switching elements. In some cases, the voltage drops are selected such that the switching elements will all switch at essentially the same time. For example, variability in SCR characteristics can result in some SCRs switching on at a higher voltage than other SCRs of a same design and type. Accordingly, the balancing resistors R3, R4, R5 can have different resistance values to compensate for such variability of the SCRs. The one or more switching elements SC1 can be connected in parallel with a reverse diode D4. The forward directional switching circuit 110 connects between a first terminal of the energy-storage component C1 and the load 120.

The reverse directional switching circuit 130 can connect between the load 120 and the first terminal of the energy-storage component C1. The reverse directional switching circuit 130 may or may not have identical circuit components to the forward directional switching circuit 110. Further, the reverse directional switching circuit 130 may or may not have a same number of circuit components that are in the forward directional switching circuit. In some implementations, the reverse directional switching circuit 130 can connect between an opposite side of the load than the side to which it is connected in FIG. 1A. In such an implementation, there can be a second inductor in the circuit branch that contains the reverse directional switching circuit 130 to allow inversion of the voltage polarity on the energy-storage component C1 (energy can transfer from the energy-storage component C1 to the second inductor and then back to the energy-storage component C1 with the correct voltage polarity for the start of the next cycle). The second inductor can connect in series with the reverse directional switching circuit 130. The second inductor can have a different value of inductance than that of the load 120, so that the inversion can take more or less time than the initial delivery of energy to the load.

Components R6 and C2 are included as a snubber suppression circuit in the system. It is located in parallel with the load in the system 100 but can be located elsewhere in the system 100. The snubber circuit, in the location shown in FIG. 1A, can help provide protection for both directional switches 110, 130 from overvoltage spikes. When located between the two directional switches, only one snubber circuit is needed rather than two snubber circuits (one across each directional switch). Additionally, there is significantly less energy loss from the snubber circuit in this location than if the snubber were placed in the usual location across the switch, where it is completely charged and discharged at each switch operation.

The circuit components used in the system 100 can have a wide range of values and be selected for a particular application. Example values for the energy-storage component (energy-storage component C1) can be any value in a range from 10 picofarads to 1 microfarad, 1 microfarad to 10 microfarads, 10 microfarads to 1 millifarads, or 1 millifarad to 100 millifarads, though lower or higher values can be used. Example inductance values for the load inductor L1 can be any value in a range from 1 nanohenry to 100 nanohenries, 10 nanohenries to 10 microhenries, 1 microhenry to 100 microhenries, or 10 microhenries to 1 millihenry, or 100 microhenries to 100 millihenries, though lower or higher values can be used. For high-speed applications, resistors R1, R2, R5, and R6 can all have values less than 100 ohms, 25 ohms to 500 ohms, or in some cases 500 ohms to 1,000 ohms. Higher resistance values can be used for other applications. Load-balancing resistors R3 and R4 can have resistance values in a range from 10 kiloohms to 1 megaohm. Values of capacitance for energy-storage component C1 and/or inductance for load L1 can be selected to achieve desired pulse width and amplitude for an application. Values of R1 and R2 can be selected to obtain a desired charging rate of the energy-storage component. Values of R3, R4, R5, R8, R9, and R10 can be selected to obtain desired balancing for the switching elements SC1, SC2.

During operation, the system 100 can cyclically apply pulses of current (and/or voltage) to the load 120. In high current and/or high voltage applications, the system 100 may operate for at least one hundred cycles or 1,000 cycles in some cases, or even up to 10,000 or more cycles in continuous operation before the system in which the circuit is implemented needs servicing (e.g., servicing of the load). Example circuit configurations for an operational cycle are depicted in FIG. 1B. The forward directional switching circuit 110 is depicted as directional switch SW2 and the reverse directional switching circuit 130 is depicted as directional switch SW3. It will be understood that the directional switch SW2 can be implemented as the forward directional switching circuit 110 of FIG. 1A and the directional switch SW3 can be implemented as the reverse directional switching circuit 130. An example of time-varying voltage across the energy-storage component C1 for one cycle is depicted in FIG. 1C. An example of current flow through the inductor L1 for one cycle is depicted in FIG. 1D.

For a portion of an operational cycle (from time t=t₀ to time t=t₁), the system 100 is in a state 0 configuration (same configuration as state 4, also indicated in FIG. 1C and FIG. 1D) where switch SW1 is in a closed (conducting) state and switches SW2, SW3 are each in an open (nonconducting) state. This portion of the cycle may be referred to as a “charging stage.” During the charging stage, the supply Vₛᵤₚₚ can deliver energy to the energy-storage component such as to, for example, charge up energy-storage component C1 with a first voltage polarity). When a sufficient amount of energy is accumulated in the energy-storage component, the supply may be switched off by opening switch SW1. In some cases, the supply can be isolated from the circuit after energy delivery with one or more power MOSFETs or other switching element SW1 connected between diode D1 and resistor R1 or between resistor R1 and resistors R2, for example.

In a next portion of the cycle (from time t=t₁ to time t=t₂), the system 100 transitions to state 1 when the forward directional switch SW2 activates to a conducting state and allows the flow of current and energy from the energy-storage component C1 to the load 120. This portion of the cycle can sometimes be referred to as a “delivery and recovery stage.” For the illustrated example of FIG. 1A where SCRs are used for the switching elements SC1, SC2, the forward directional switching circuit 110 can turn on automatically when voltages across the SCRs exceeds a threshold amount or turn-on voltage that will switch the SCRs into forward conduction. In some implementations, the SCRs may be turned on by other circuitry that applies a pulse to the control gates of the SCRs.

Regardless of how the switch SW2 activates, when it is in a conducting state, current and energy will then flow into and through the load 120. Current and energy that passes through the load can accumulate (be recovered) back in the energy-storage component C1, reversing the voltage across C1. At some point during the delivery and recovery stage, the voltage across the energy-storage component C1 will drop to zero and then a reverse voltage will begin to appear across it. Because of the inductor L1 in the load, the current will continue flowing to the energy-storage element C1, increasing the reverse voltage. With sufficient reverse voltage, the current flowing through the load and forward directional switch SW2 will drop to zero. For the switching circuit implementation of FIG. 1A, the current drops below a holding current for at least one of the SCRs, which will change the forward directional switch SW2 to an open state.

In a next portion of the cycle (from time t=t₂ to time t=t₃), the system 100 transitions to state 2 where the current exiting the load has stopped flowing. This portion of the cycle can sometimes be referred to as a “first holding stage.” The forward directional switch SW2 and the reverse directional switch SW3 are open, and the recovered energy can be held in the energy-storage component C1 for an extended period of time. The ability to hold the recovered energy for a period of time can be beneficial in some systems for system recovery (e.g., to let some system components recover, dissipate heat, terminate any ringing, settle, remove and/or replenish consumables, etc.). The first holding stage may be omitted if system recovery is not needed.

In a next portion of the cycle (from time t=t₃ to time t=t₄), the system 100 transitions to state 3 where the voltage across the energy-storage component is reversed. This portion of the cycle may be referred to as an “inversion stage.” The reverse directional switch SW3 is activated to a conducting state allowing current to flow between the terminals of the energy-storage component C1 which reverses the voltage across the energy-storage component (as can be seen in FIG. 1C). The reversal of voltage restores the polarity across the energy-storage component to its original polarity at time t₁, though not to the same magnitude.

For the present implementation, the energy flows back through the load 120 during the inversion stage. In other circuit implementations described below, the energy can flow back through another circuit branch that does not include the load. Activation of the reverse directional switch SW3 can be automatic and may be based on the voltage applied across the reverse direction switch SW3 (as described above for the forward directional switch SW2) or in response to a control signal (e.g., a timed, trigger signal from a system controller) applied to control gates of the SCRs or transistors. The result of the inversion stage is to restore the system to nearly its state at the end of the charging state, where recovered energy is in the energy-storage component C1 with a correct polarity for the next cycle.

In a next portion of the cycle (from time t=t₄ to time t=t₅), the system 100 transitions to state 4 where the energy is held in the energy-storage component for the start of the next cycle. This portion of the cycle may be referred to as a “second holding stage.” The forward directional switch SW2 and reverse directional switch SW3 are open, and the recovered energy can again be held in the energy-storage component C1 for an extended period of time. The holding of energy can be beneficial to let the system recover, as described above for the first holding stage. The second holding stage can be omitted if system recovery is not needed. During or following the second holding stage, the supply Vₛᵤₚₚ can be switched back on to top off the energy on the energy-storage component C1 so that the system is ready to execute a next cycle.

The inventors have recognized and appreciated that switching large currents and high voltages can create significant challenges for directional switches in energy-recovery circuits or circuits for pulsed power applications. For example, and referring to the forward directional switching circuit 110 of FIG. 1A where SCRs are used for the switching elements SC1, SC2, the SCRs can readily turn on for forward conduction during the delivery and recovery and the inversion stages of the cycle. However, turn-off of the SCRs can be complicated by the presence and creation of significant heat and by reverse potentials across the SCRs, either of which might damage the SCRs if not mitigated and/or handled appropriately. Similar complications arise for other switching elements, such as IGBTs.

During forward conduction, a significant amount of current can be flowing through the SCRs. In some cases, the amount of forward current can reach 200 million amps or more. This amount of current can significantly heat the SCRs to temperatures near their maximum allowable limit. The high heat can generate free carriers in the active region of the SCRs which should be removed so that the SCRs can turn off and block reverse current flow when a reverse potential begins to appear across the SCRs and the forward current drops below the SCR's holding current. In a practical implementation, the heat may not dissipate quickly enough, such that it continues to generate carriers which allow conduction of reverse current, even though the forward current has dropped below the holding current for the SCR (where the SCR would normally shut off and block the reverse current). The free carriers can cause the SCRs to have a higher leakage current than they would normally have when operated at ambient room temperature. As the reverse current begins to flow and increases with reverse bias, the SCR tries to shut off which increases its resistance from a low value (e.g., less than 100 ohms in forward conduction) to a high value (e.g., well over 1,000 ohms). When the resistance in the SCR increases while reverse current flows, the power dissipation and heat in the SCR can spike since both quantities relate to the product of current (squared) and resistance: I²R. The dissipated heat is an unwanted power loss. Further, such a spike in heat in addition to heat already present may damage an SCR. Additionally or alternatively, the reverse voltage that develops across the SCR may exceed its breakdown voltage, which may be significantly lower than a specified breakdown voltage (measured at room temperature) if the SCR is at a significantly elevated temperature.

To handle reverse current and voltages, the forward directional switching circuit 110 and the reverse directional switching circuit 130 can include the forward diodes D3, D5 and the reverse diodes D4 and D6, respectively. When a reverse voltage begins to form across either switching circuit 110, 130, the forward diodes D3, D5 begin blocking current before the SCRs turn off. Because of their higher resistance, the forward diodes can also drop most of the reverse voltage that forms across the switching circuit, rather than the reverse voltage being applied across the one or more switching elements SC1, SC2. The larger voltage drop across the forward diodes can, for example, mitigate reverse voltage across the SCRs (when used as a switching element) and help prevent damage to the SCRs by reverse voltages. The reverse diodes D4, D6 further control the reverse voltage drop across the switching element(s) to a low value (e.g., one forward-biased diode drop). Additionally, the reverse diodes D4, D6 provide a low impedance path for reverse current to flow around the SCRs, which can mitigate heating of the SCRs. The forward diodes D3, D5 and the reverse diodes D4, D6 can protect the switching elements SC1, SC2 from excess heating and large reverse voltages when reverse voltages form across the forward switching circuit 110 and the reverse switching circuit 130. The handling of reverse current flow, reverse voltage, and associated power dissipation in a blocking device (sometimes referred to as “turn-off energy” or “recovery energy”) is diverted from the switching elements SC1, SC2 to the forward diodes D3, D5 in the directional switches 110, 130. In some implementations, at least 70% of the total recovery energy is diverted from the switching elements to the forward diodes. In some cases, up to 98% of the total recovery energy is diverted from the switching elements to the forward diodes. The recovery energy can be measured as the sum of power dissipated in each blocking device (e.g., switching elements SC1 and forward diode D3 integrated over the time it takes the directional switch to shut off the current flow. The diversion of recovery energy to the forward diodes can prevent failure of the switching elements SC1, SC2 when the switching elements are operated near their maximum limit under forward conduction.

The diversion of recovery energy to the forward diodes can also allow the switching circuits 110, 130 to commutate when up to one million watts of recovery energy (over a recovery time scale for the switching circuit of 1 microsecond to 250 microseconds) is to be handled by the switching circuit. Longer recovery times for the switching circuit may be possible in some cases. Operating the system 100 in pulsed mode with idle time between pulses can also allow higher peak currents, powers, and energies to be handled by the directional switches 110, 130. The idle time, which can be significantly longer than the pulse width (e.g., by at least a factor of 5) can allow for heat to be dissipated by the blocking devices in the directional switches.

The forward diodes D3, D5 can be robust for high current, high voltage applications. For example, the forward diodes may be rated to handle over one million amps in forward conduction and block over one thousand volts under reverse bias. Examples of such diodes are the Mega Power Pulse Diodes available from VR Electronics Co. LTD. of Markham, Ontario, Canada. Such diodes can be large in size (up to 50 mm diameter, or larger). The reverse diodes D4, D6 can be significantly smaller since they only need divert reverse current flow from the SCRs. Diodes D4, D6 can be low energy bypass diodes, including axial devices that conduct current only during part of the time that diodes D3, D5 go into reverse blocking and the SCRs turn-off and recover. For example, the reverse diodes can be rated to handle a few amps with a reverse breakdown potential of less than 500 volts. In some implementations, the forward diodes' forward current level and reverse voltage blocking level can each be at least an order of magnitude larger than corresponding levels for the reverse diodes D4, D6. The diameter of the reverse diodes D4, D6 can be less than 10 mm.

The design of the forward switching circuit 110 and reverse switching circuit 130 allows for use of moderate or slow speed rectifying diodes for the forward diodes D3, D5. Use of moderate or slow-speed diodes in these circuits can be beneficial because they can handle large forward currents (e.g., peak currents up in the millions of amps or more), have lower forward resistance, have low leakage currents (some on the order of microamps), and be lower in cost than high-speed diodes. As an example, a moderate or slow-speed diode may have a recovery time on the order of 1 microsecond to 100 microseconds, any subrange within this range, or a longer timescale compared to less than 100 ns for a fast recovery diode.

FIG. 1E is a simplified model 102 of the circuit of FIG. 1A. The model omits the charging circuitry and shows the energy-storage component in an initially charged state (with a polarity indicated by the plus sign). The model also depicts the forward switching circuit 110 and reverse switching circuit 130 as directional switches SW1 and SW2, respectively. In the illustration, the directional switches are depicted as a mechanical switch in series with a diode, though other directional switches (such as those described in connection with FIG. 17A through FIG. 17E) may be used for some implementations.

2.2b Description of Energy-Recovery Circuits that Use an Alternate Circuit Path Around the Load During Recovery

FIG. 2A depicts a simplified circuit 200 for an electrical system that performs energy recovery and operates with repeated cycles. For this system, energy is recovered from the load onto the same energy-storage component that is used to store and deliver the initial energy to the load, like the system of FIG. 1A. However, the inversion stage of the operational cycle (to invert the polarity of the voltage stored on the energy-storage component C1) flows current through an alternate circuit path 150 that does not include the load. Flowing current through an alternate circuit path 150 can be beneficial in some applications (e.g., if reversal of current through the load is not desirable, to avoid heating and/or stressing the load with the return current, to avoid field reversal in an electromagnet, etc.). Further, the size of the inductor L2 in the alternate circuit path 150 can be increased to slow the current flow and reduce the peak current flowing through components (such as diode D2) in the alternate circuit path. Reducing the peak current can allow use of circuit components with lower current ratings, which can be smaller in size and less costly than components rated for higher currents. Also, slowing the current flow can allow more time for the system to recover from the forward pulse of current.

For the implementation of FIG. 2A, only one directional switch SW2 is used to operate the system for a full operational cycle. For example, after the energy-storage component C1 is initially charged and switch SW1 opens, directional switch SW2 can close at time t₁ for a period of time to deliver power to the load 120. Energy passing through the load begins to accumulate in the energy-storage component C1, but with reversed voltage polarity. When the current through the directional switch SW2 falls to zero, SW2 can open while energy stored in the energy-storage component C1 and inductor L2 drives current through inductor L2 to reverse the voltage on the energy-storage component C1 during the inversion stage of the cycle.

In some implementations, the inductance of L2 can be 2-3 times the inductance of the load. Having a higher inductance for L2 can reduce and slow the current flow during the inversion stage, as described above. When SCRs are used for the directional switch SW2, the slowing of current flow can be important to allow enough time for the SCRs to self-commutate and open before the voltage across the energy-storage component becomes a significant positive value which would keep the SCR on prevent completion of the inversion stage.

FIG. 2B and FIG. 2C depict simulated voltage and current waveforms, respectively, for components of the circuit of FIG. 2A. The waveforms for FIG. 2B and FIG. 2C (and for the waveform plots below for other circuits described herein) are plotted for a time that begins just after an initial charging of the system's energy-storage component which subsequently delivers its energy to the load 120.

FIG. 2D depicts a simplified circuit 202 that is a variation of the circuit of FIG. 2A. A second directional switch SW3 is used instead of the diode D2 in the alternate circuit path 150. The voltage waveform across the energy-storage component C1 is plotted in FIG. 2E and the current waveforms through the two inductors are plotted in FIG. 2F. The voltage and current waveforms illustrate the slower inversion stage of the cycle, during which the voltage polarity on the energy-storage component C1 is inverted back to its initial polarity.

A desirable feature of the circuit of FIG. 2A (compared with the circuit of FIG. 2D) is that the voltage across the energy-storage component C1 does not fully reverse (compare the voltage traces in FIG. 2B and FIG. 2E). When a capacitor is used as the energy-storage component, avoiding voltage reversal across the capacitor can significantly decrease the size and cost of the capacitor. For example, reducing the total voltage swing across the capacitor by a factor of two can reduce its volume by a factor of four. Lowering the inductance of the inductor L2 in the inverting alternate circuit path 150 of FIG. 2A can further reduce the voltage inversion on the energy-storage component C1. However, it is preferable to keep the inductance of L2 greater than that of L_load for some circuit implementations (e.g., to avoid latching SCR(s) in the directional switch prior to the inversion stage of the operational cycle).

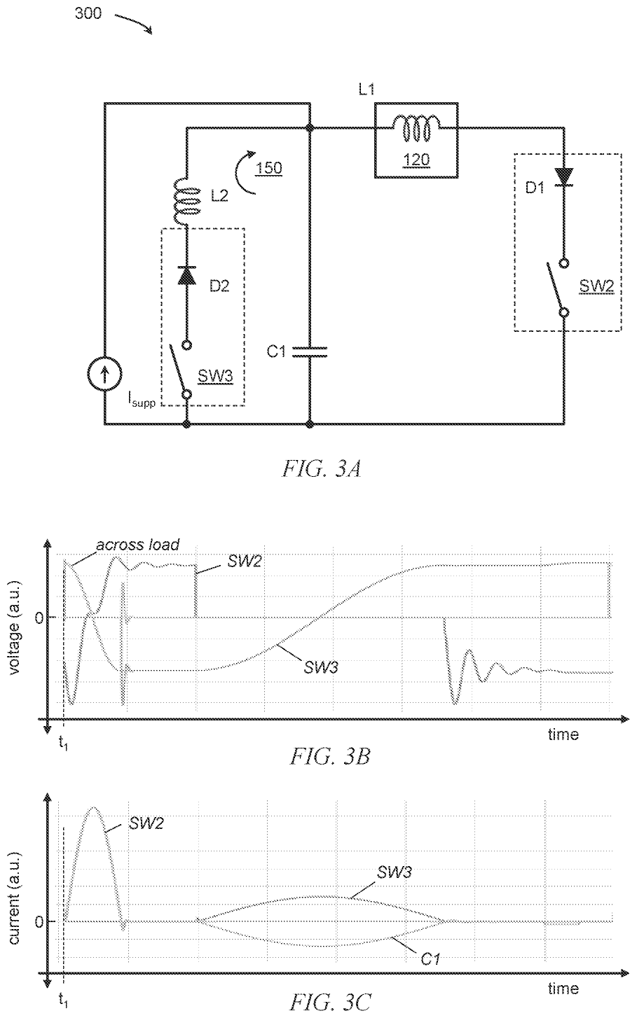

FIG. 3A depicts a simplified circuit 300 for an electrical system that performs energy recovery and operates with repeated cycles. The system is similar to that shown in FIG. 2D, except that a controllable current source (which may be programmable) is used to charge energy-storage component C1 at the beginning of each cycle (e.g., with a pulse of current). In this regard, other circuits described herein may use current sources rather than depicted voltage sources to charge the energy-storage component. Also, circuits described as having current sources may use voltage sources and a switch instead.

For the system of FIG. 3A, switch SW2 can close after energy-storage component C1 is charged, so that current can flow through the load 120. By placing switch SW2 on the other side of the load 120, the switch may close when there is no voltage across the switch. Current can then flow to and through the load and accumulate in energy-storage component C1, reversing its polarity. Switch SW3 can close at a later time and switch SW2 open to invert the polarity of voltage across the energy-storage component C1. Current can flow through the inductor L2 during the inversion stage to restore the voltage polarity across the energy-storage component C1 to the initial polarity for the next operational cycle.

FIG. 3B and FIG. 3C depict simulated voltage and current waveforms, respectively, for components of the circuit of FIG. 3A. The current waveforms show a time-separated flow of current through the two switches SW1, SW2 as they alternately close and open. The current waveforms also show a slower inversion stage than the delivery and recovery stage.

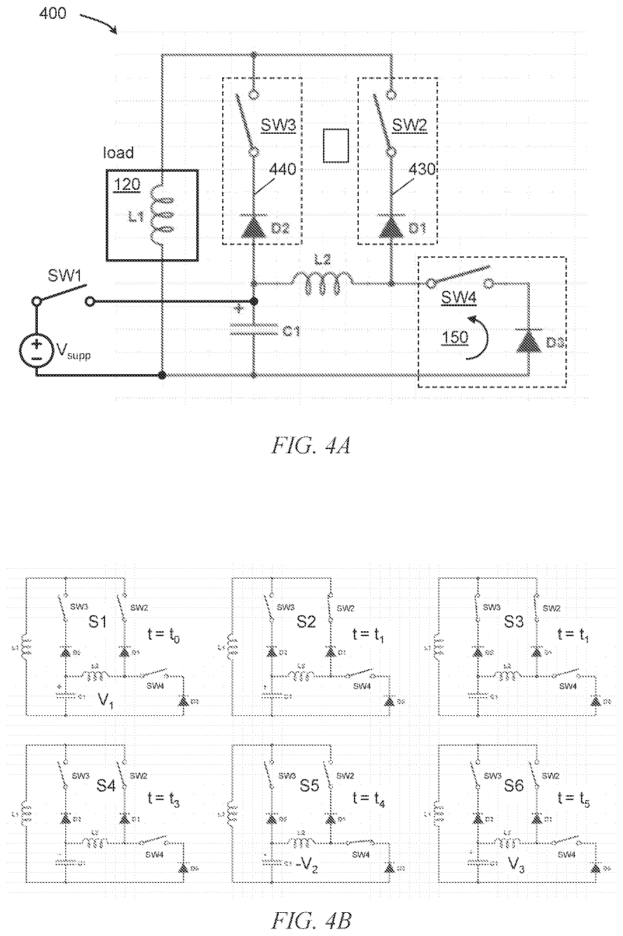

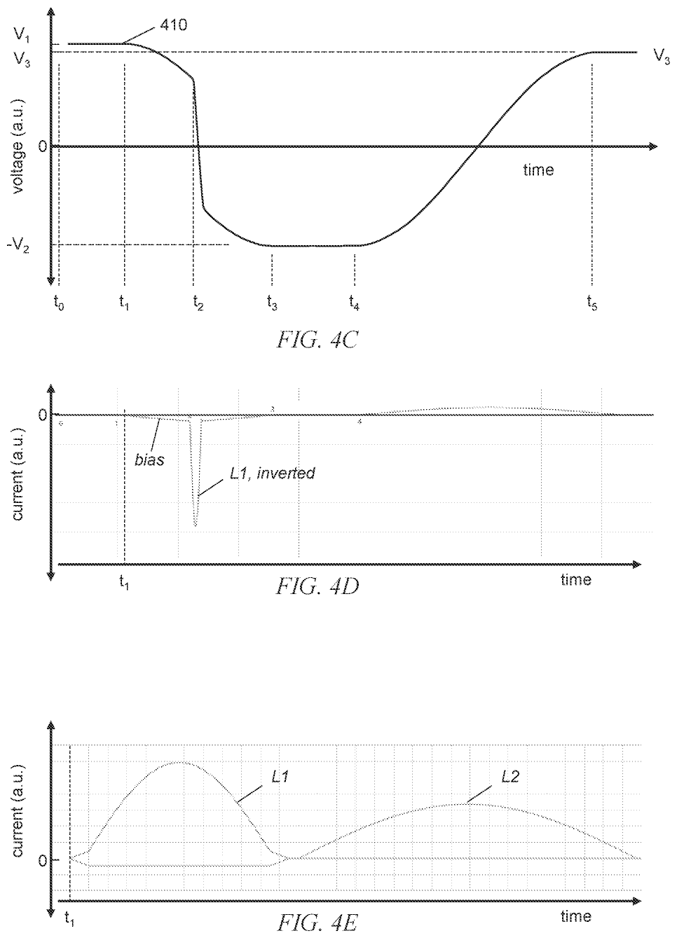

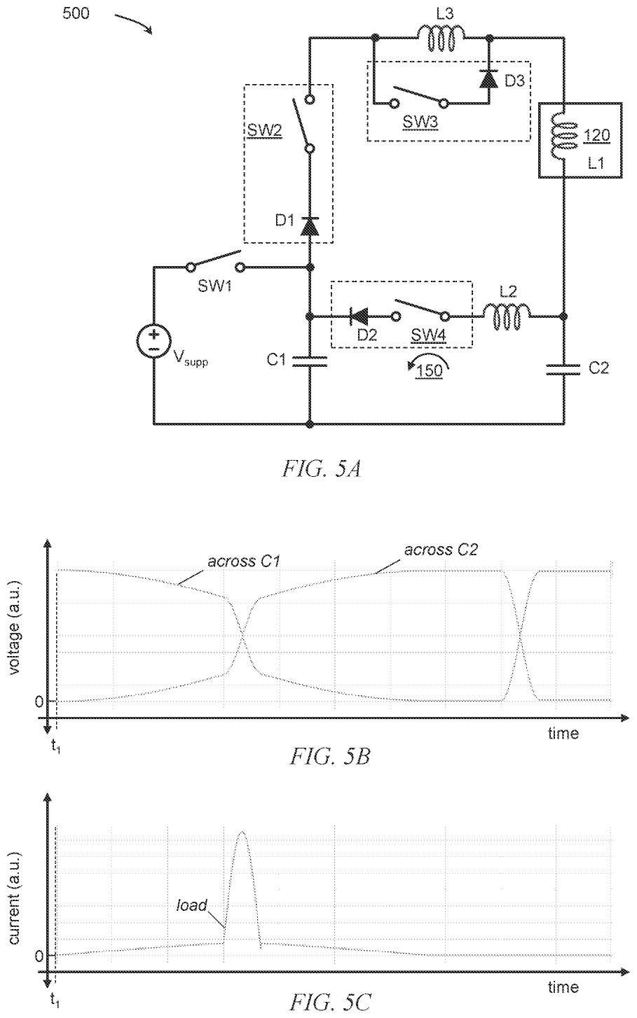

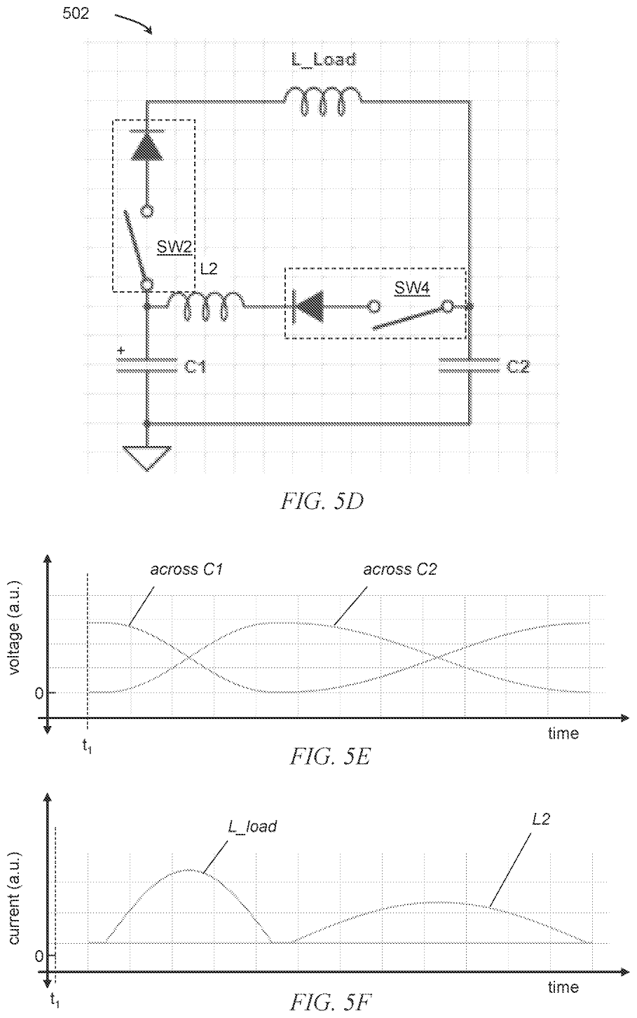

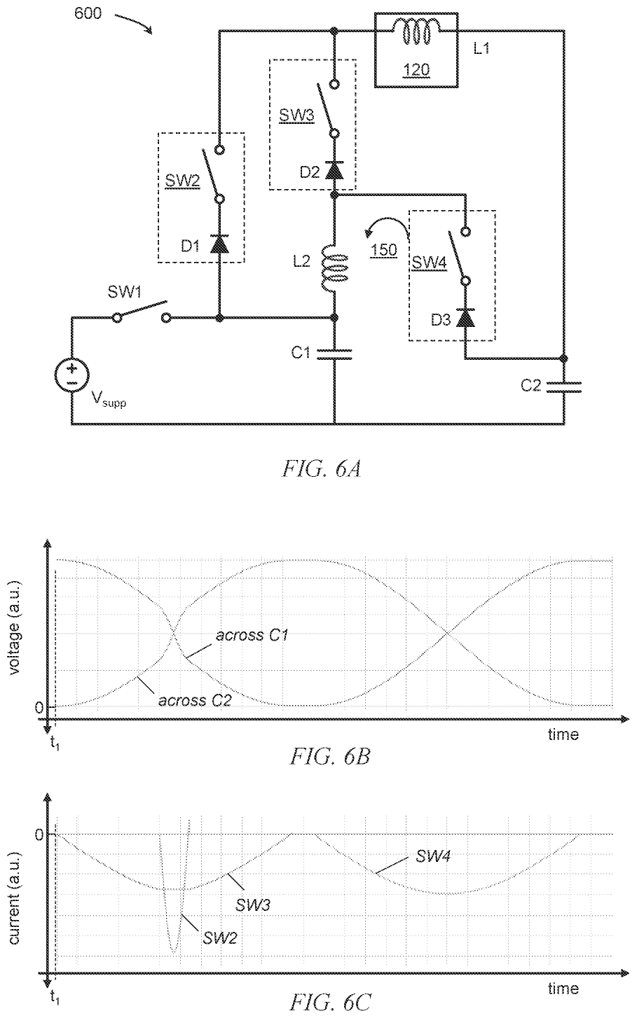

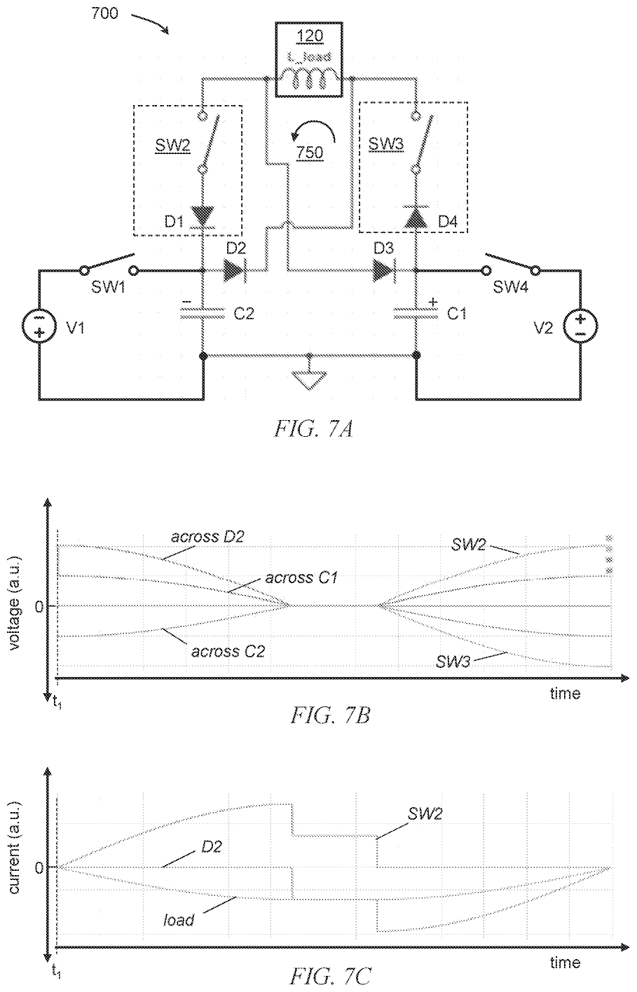

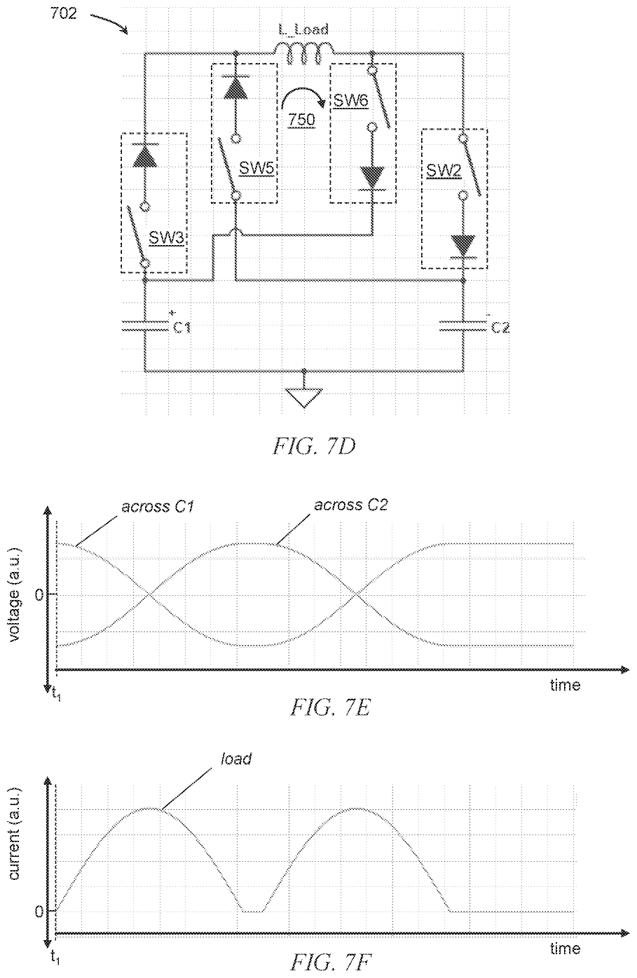

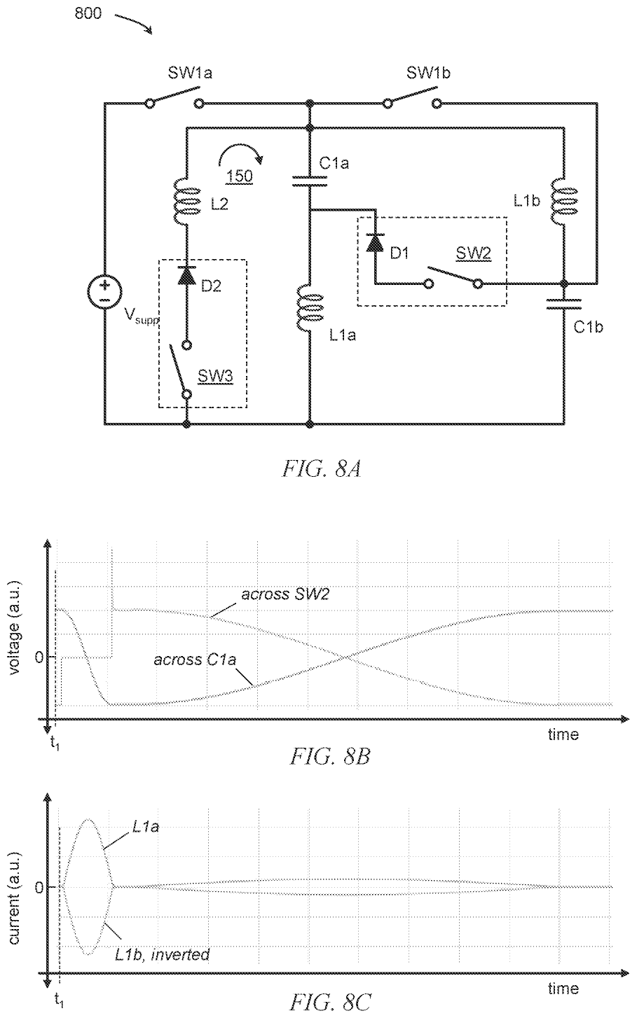

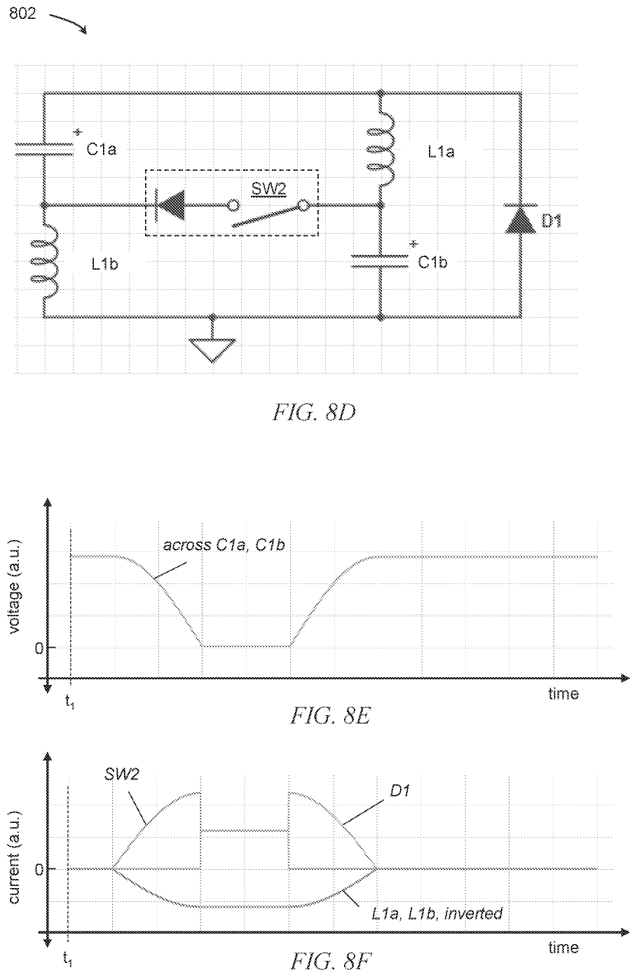

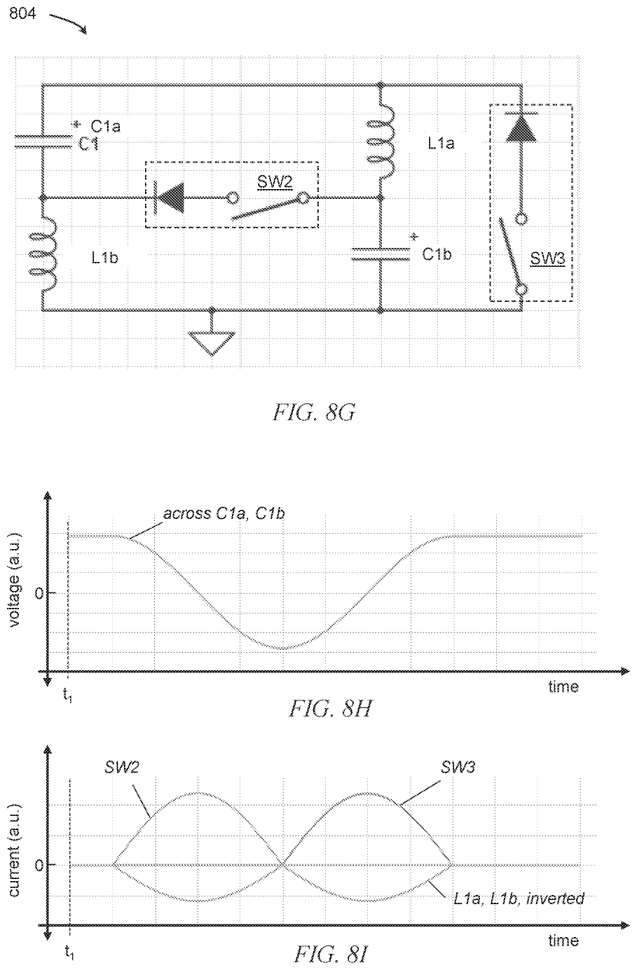

FIG. 4A depicts a simplified circuit for an electrical system 400 that performs energy recovery and can operate with repeated cycles. Like other energy-recovery circuits described herein, the system is designed to recover energy remaining in the system after execution of a function during each cycle and make the recovered energy available for a next operational cycle of the electrical system. The system 400 includes another feature which may be referred to as “pulse shaping.” Pulse shaping is also possible with the systems of FIG. 5A and FIG. 6A and other systems described herein. As used herein, “pulse shaping” means forming a pulse of current having a shape that is different than the half-cycle pulse of current that would result from the discharge of charge on a capacitor into an inductive or inductive and resistive load. A slow rise or bias pulse combined with a fast rise main pulse (as seen in FIG. 4D) is one example of a shaped pulse. A current pulse with a flat top (as seen in FIG. 7C and FIG. 8F) are additional examples of shaped pulses. Pulse shaping can be useful for some applications where, for example, a slow rise time in current followed by a rapid increase and/or a flat top pulse is desired. Aspects of pulse shaping are described further below in Section 2.4 and in connection with other systems. In some circuits, pulse shaping can be implemented by timing of switches.

The electrical system 400 can include one or more energy-storage components (e.g., one or more capacitors or capacitive components modeled as energy-storage component C1 in FIG. 4A, one or more inductors, or a combination thereof), the load 120 (e.g., one or more magnetic coils or inductive components modeled as inductor L1), one or more second inductors (modeled as L2), and a plurality of switches SW1, SW2, SW3, SW4 connected as shown. There can be a power supply to deliver energy to the energy-storage component (e.g., charge the capacitor or cause rotation of the flywheel). For the illustrated implementation, the power supply comprises a voltage source Vₛᵤₚₚ arranged to connect to the energy-storage component C1 with a first switch SW1. In some cases, the power supply may be a high-voltage supply to deliver a voltage value between 500 volts and 50,000 volts and provide a peak current of up to 50 amps or more, though supplies operating at lower or higher voltages and delivering less or more current may be used for some implementations. For example, some power supplies may be arranged in series or in parallel to deliver higher voltages and/or higher currents when charging the energy-storage component to an initial energy level.

There may be at least one diode D3 in the alternate circuit path 150 to resist backward flow of current from inductor L2 and energy-storage component C1 during an inversion stage of a cycle. In some cases, the diode D3 is part of a directional switch SW4, indicated with the dashed lines. Diodes D1 and D2 may or may not be included in the circuit. If included, diodes D1 and D2 may be present as part of directional switches SW2 and SW3 or may be added as separate discrete components. Inductor L2 may be a lumped element or distributed inductance.

During operation, the electrical system can pass through several states during each operational cycle to perform a function associated with the load 120 (e.g., accelerating a particle or object, creating a strong magnetic field, swaging, moving an armature, rotating a motor, etc.). Example operational states of the system 400 are represented in the simplified circuits of FIG. 4B. A corresponding evolution of voltage across the energy-storage component C1 for a portion of a cycle is plotted in FIG. 4C. At time t to (not shown in FIG. 4B), switch SW1 to the power supply Vₛᵤₚₚ may close to charge energy-storage component C1 to a working voltage V₁ and energy level. After the energy-storage component C1 charges to the desired voltage, the switch SW1 opens placing the circuit (and system 400) in an initial state S1 at time immediately before t=t₁. At time t=t₁, the system transitions to the second state S2 where switch SW2 closes to start delivering energy stored in energy-storage component C1 to the load 120 via a first circuit branch 430. The initial energy flows through an inductor L2, which can provide an initial slow bias of current and energy to the load (e.g., a soft start-up when activating the load). In some applications, such a soft start-up can reduce mechanical and/or electrical stresses on components of the load 120 and prolong the operational lifetime of the load.

Subsequently at time t=t₂, the system transitions to a third state S3 where switch SW3 closes providing a more rapid delivery of current, as compared with the second state S2, from the energy-storage component C1 to the load 120 through a second circuit branch 440. Switches SW2 and SW3 may then remain closed while the function is performed by the load 120 and the voltage across the energy-storage component C1 reverses to a first peak value (−V₂ in this example). State S3 essentially forms an LC circuit in which energy in the system will transfer from the energy-storage component C1 to the inductor L1 and then back to the energy-storage component C1.

When the first peak value of reversed voltage on the energy-storage component C1 is reached, the system can transition to state S4 for an interval of time (all switches open at t=t₃) and then to state S5 which begins at time t=t₄ when switch SW4 closes. In some cases, state S4 may not be attained and the system may transition directly from state S3 to state S5. When switch SW4 closes, an alternate circuit path 150 is formed for which energy stored in the energy-storage component C1 and having a reversed polarity (compared to the start of the cycle) can be output to the inductor L2 and then provided back to the energy-storage component C1, inverting the polarity back to the initial polarity for the next operational cycle of the system. The alternate circuit path 150 allows for inversion of the voltage −V₂ on the energy-storage component C1 between the start of state S5 at t=t₄ and the beginning of state S6 at t=t₅ where the voltage on the energy-storage component C1 reaches a peak recovery voltage V₃. Because of system losses (e.g., parasitic losses from resistive components in the system), the magnitude of the voltage V₃ may be less than the magnitude of voltage −V₂. When the recovery voltage is reached, switch SW4 opens placing the system in a ready state S6 for a next operational cycle with recovered energy stored in the energy-storage component C1 with a correct polarity. Switch SW1 may then close at the start of the next operational cycle to top off or fully charge the energy-storage component C1 and initiate the next cycle of operation. The electrical system 400 can be in each of the states S1 through S6 for a portion of an operational cycle.

FIG. 4C depicts an example voltage waveform on the energy-storage component C1 for the states S1 through S6 described in connection with FIG. 4B. The plot shows the voltage evolution from an initially positive-charged voltage V₁ (which may be less than or approximately equal to the supply voltage Vₛᵤₚₚ) to a negative voltage −V₂ and reversal back to a positive recovery voltage V₃ for the start of a next cycle. The amount of energy recovered per cycle for this circuit that is not consumed by the load (as well as other energy-recovery circuits described herein) can be up to 90% and higher. In some cases, the amount of energy recovered can be between 85% and 95% or between 90% and 97%. If there were no loss mechanisms in the system, then the voltage V₃ would equal the voltage V₁.

In some implementations, the voltage V₃ may be higher than the voltage V₁ and the additional electrical energy may be tapped off of energy-storage component C1 by an additional switch and circuitry (not shown) to harvest the additional energy. Excess energy could result from a number of influences such as an armature being inserted into or moved through the inductor L1 of the load. The armature may be a flux excluder in the form of an electrically conductive body such as a metal or plasma. The same effect can be realized by expanding an electrically conductive body, or magnetic field, inside the inductor L1 as well. This may be accomplished by physical means such as combustion, through heating a plasma inside the inductor, or by releasing or applying a plasma pressure induced by an external or internal source, respectively. Should the load 120 produce a back-EMF such that the energy in the load is increased, the circuit of FIG. 4A allows for the direct conversion of that back-EMF energy to stored electrical energy (in energy-storage component C1 in this example). The aspect of harnessing additional energy applies to the other system implementations described herein in connection with FIG. 1A through FIG. 16A and FIG. 20A through FIG. 22.

FIG. 4E depicts current waveforms through the inductors of a same circuit as that shown in FIG. 4A, but with different inductance values. In this case, the inductance of L2 is closer in value to the inductance of L1 than for the case plotted in FIG. 4D. As a result, the bias shoulder lasts for a brief amount of time in FIG. 4E followed by a much broader peak pulse than for the case of FIG. 4D. Accordingly, pulse shaping of energy delivered to the load 120 can be accomplished by changing the value of inductance for inductor L2.

The electrical system 400 that can be modeled by the circuit illustrated in FIG. 4A has several desirable features, apart from recovering more than 90% of the inductively-stored energy from the load 120 for each operational cycle. The circuit can provide an initially reduced, slower-risetime, current (which may be referred to as a “bias current” or “soft start-up current”) to initially deliver a portion of the energy from the energy-storage component C1. This soft start-up current is depicted as the initial, slow drop in voltage in FIG. 4C and initial slow increase in magnitude of current in FIG. 4D from times t₁ to t₂. Subsequently (immediately following time t₂), a faster current flow is provided.

Another feature of the electrical system 400 is that inversion of the voltage on energy-storage component C1 can be done with only an inductor L2 and a directional switch SW4. This inversion can be performed independently from the soft start-up and the inversion can be done at a lower current level than the peak forward current through the load. Additionally, the inductor L2 is used for two independent functions: providing an initial soft start-up of power to the load 120 and inverting the voltage on the energy-storage component C1 during the inversion stage.

Values of system components for the system of FIG. 4A (e.g., inductor L2, energy-storage component C1) and for other systems described below can be selected to achieve desired operating characteristics during each stage of the system's operational cycle. For examples where there is low resistance (e.g., less than 10 ohms) in the circuit paths, the charging and discharging rates of the energy-storage component C1 may be determined in part by the ringing or resonant frequency for the inductive and capacitive components in the circuit path. The ratio of reactive impedance to resistance may also be used to determine the charging and discharging rates of the energy-storage component C1. In some cases, the value of the load L1 may be limited by mechanical design to a range of values and thereby limit the choices for L2 and C1. In some cases, L2 (when used) may have an inductance that is within an order of magnitude of the value of L1. In some cases, the value of L2 may be within three orders of magnitude of the value of L1. Further, the amount of energy needed to perform the system function by the load 120 may determine the size of the energy-storage component (e.g., according to the energy storage amount of 0.5 C₁Vₛᵤₚₚ²) as well as sizes of other system components (such as components in the directional switches). Nevertheless, the electrical system of FIG. 4A can be used for a broad range of systems that drive loads 120.

In example implementations, the load may have an inductance L1 between 5 nanohenries and 100 microhenries. In some cases, the load may have an inductance L1 between 1 picohenry and 1 henry. The power supply may have a voltage between 100 volts and 50,000 volts and charge at least one energy-storage component C1 having a capacitance between 2 microfarads and 10 farads to a voltage between 1 volt and 50,000 volts. In some cases, the power supply may have a voltage between 1 millivolt and 1 megavolt and C1 may have a capacitance between 1 picofarad and 100 farads. The peak energy stored in the energy-storage component C1 may be from 1 millijoule to 100 joules per cycle, and the charging time of the capacitor may be between 100 nanoseconds and 10 seconds (or any subrange within this range). In some cases, the peak energy stored in the energy-storage component C1 may be from 1 nanojoule to 10 gigajoules.

Various types of directional switches may be used for the electrical system 400 of FIG. 4A and for other electrical systems described herein. A directional switch (e.g., switches SW2, SW3, SW4) is a device used to controllably toggle between at least two states where it can prevent or restrict the flow of current in one state and allow the flow of current in another state. Different types of switches that may be used for system implementations described herein include, but are not limited to, mechanical switches and relays, semiconductor-based switches (such as MOSFETs, JFETs, IGBTs, SCRs, gate turn-off thyristors (GTOs), and insulated gate commutated thyristors (IGCTs)), gas switches (such as ignitrons, thyratrons, and pseudo-spark switches), spark gaps, and magnetic saturable switches. For higher-frequency applications (e.g., over 10 kHz) a semiconductor-based switch might be selected. For lower-frequency, higher-power applications an insulated-gate bipolar transistor (IGBT) or silicon-controlled rectifier (SCR) may be selected. In very high voltage applications (e.g., over 5000 volts), a gas switch might be selected.

The system of FIG. 4A allows for the use of closing switches (e.g., ignitron switches) and self-commutating switching devices (e.g., SCRs). Some embodiments of circuits may require the use of opening switches (e.g., IGBTs). An advantage of closing, or self-commutating, switches is that they tend to be more economical than opening switches for any given current or voltage application. In other cases, the system of FIG. 4A may be designed to use opening switches instead of closing switches, where the switch is made to open and stop conducting at the appropriate time. The inclusion of at least some of the diodes D1, D2, D3 may depend upon the type of switch used in the associated circuit branch.

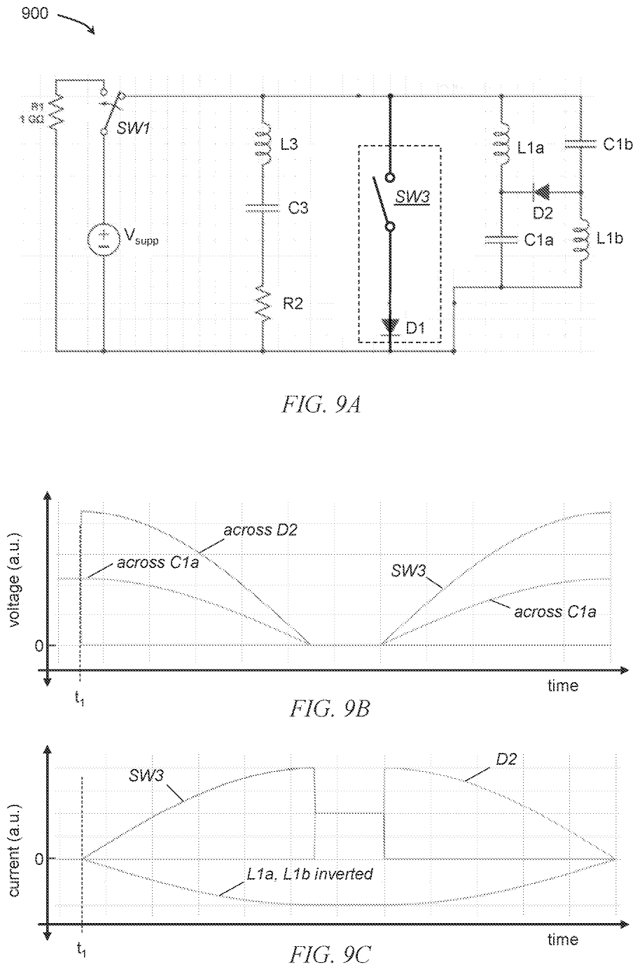

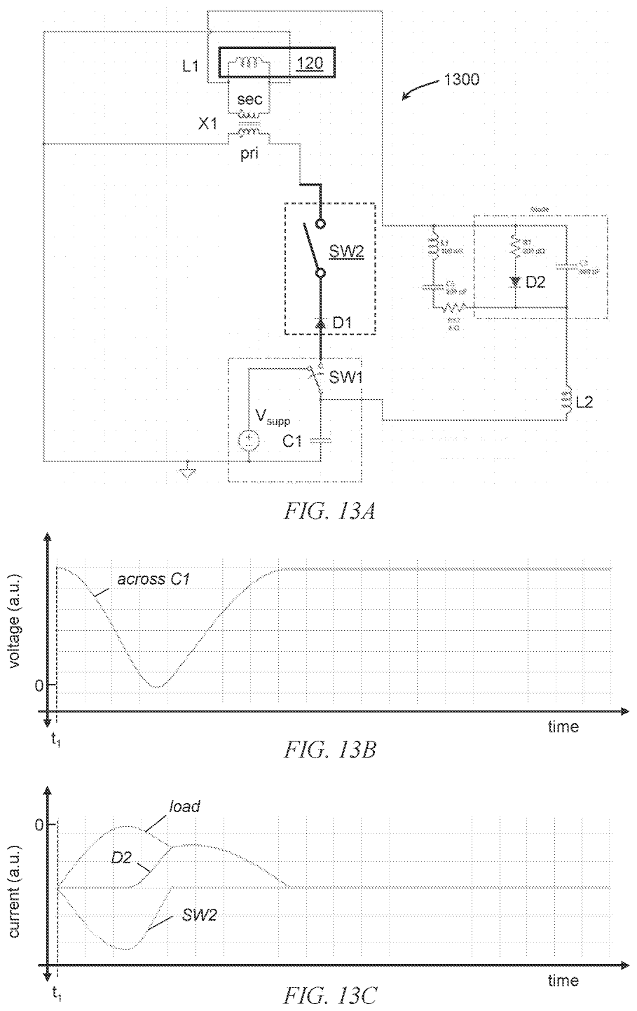

The circuit of FIG. 4A can include additional circuit components that are not shown in the drawing. For example, a diode snubber circuit (comprising a series-connected resistor and capacitor) may be included across at least diode D3 and connected in parallel with the diode D3. In some cases, the diode snubber circuit may also include an inductor in series with the resistor and capacitor. FIG. 13A shows an example of a diode snubber and model for diode D2 in that figure. A diode snubber circuit may also be included across one or both of diodes D1 and D2 of FIG. 4A. A snubber circuit may also be placed across one or both of the inductive components L1, L2 in the system. The inductor snubber circuits may be of the same design as the diode snubber circuits though the values of their resistor, capacitor, and inductor (if present) components may differ from those of the diode snubber circuits. Snubbers having diodes may also be placed across switches in the electrical system to prevent excessive reverse voltages across the switches. Snubbers for switches can include other circuit components (capacitors, inductors, resistors) like the snubber described in connection with FIG. 9A.

FIG. 5A depicts a circuit for an electrical system 500 that performs energy recovery and operates with repeated cycles. The system uses a second energy-storage component (implemented as capacitor C2) to store and recover energy from the load and provide the energy back to the first energy-storage component C1, similar to the system of FIG. 6A described below. By using the second energy-storage component C2, the voltage on the first energy-storage component does not reverse which can be advantageous for the reasons of reduced capacitor size and cost described above in connection with FIG. 2A. Even though two capacitors are used for energy storage, there can be a net reduction in cost and size compared to the single capacitor that is sized to handle full voltage reversal. The non-reversal of voltage can be seen in the plot of FIG. 5B.

The system 500 also includes soft-start powering of the load 120. For example, power is first delivered from the first energy-storage component C1 to the load through inductor L3 at a first rate of power delivery when directional switch SW2 closes. At a selected time, directional switch SW3 closes so that inductor L3 is bypassed. Current and power from energy-storage component C1 can then flow more rapidly at a second rate of power delivery to the load L1, as indicated in the current waveform of FIG. 5C. After energy accumulates in capacitor C2, directional switch SW4 closes and switch SW2 opens to transfer recovered energy from capacitor C2 to energy-storage component C1 for the start of the next operational cycle. The energy is recovered into C1 using the alternate circuit path 150.

FIG. 5B and FIG. 5C depict simulated voltage and current waveforms, respectively, for components of the circuit of FIG. 5A. The voltage waveforms show the transfer of energy from energy-storage component C1 to capacitor C2 and back to energy-storage component C1 during an operational cycle.

FIG. 5D is a simplified circuit 502 for a variation of the system of FIG. 5A. The circuit 502 is shown in an initial charged state and the supply circuitry is omitted. The circuit 502 does not include the soft-start feature (directional switch SW3 is removed). Voltage and current waveforms are shown for the circuit 502 in FIG. 5E and FIG. 5F.

FIG. 6A depicts another circuit for an electrical system 600 that performs energy recovery and operates with repeated cycles. The system includes a second energy-storage component C2 and operates similar to the system of FIG. 5A. For this system, energy initially stored in energy-storage component C1 is delivered to the load 120 and then accumulates in the second energy-storage component C2. Like the system of FIG. 5A, the voltages across the energy-storage components do not reverse polarity, as can be seen in FIG. 6B.

Like the systems of FIG. 4A and FIG. 5A, this system 600 also includes a soft start-up for powering the load 120. During each cycle, directional switch SW3 can close before directional switch SW2 to deliver power from the energy-storage component C1 through inductor L2 at a slower rate than when switch SW2 subsequently closes. The rapid flow and higher peak of current following the activation of directional switch SW2 can be seen in FIG. 6C.

To recover energy from the second energy-storage component C2 to the first energy-storage component, directional switch SW4 can close while switches SW2, SW3 open. The flow of current along the alternate circuit path 150 can transfer energy from capacitor C2 to capacitor C1.

FIG. 6B and FIG. 6C depict simulated voltage and current waveforms, respectively, for components of the circuit of FIG. 6A. The voltage waveforms indicate how energy transfers from the first energy-storage component C1 to the second energy-storage component C2 and then back to C1. The current waveform for switch SW2 shows a more rapid delivery of current to the load when the switch closes.

2.2c Energy-Recovery Circuits that Pass Current Through the Load when Restoring the Correct Voltage Polarity on the Energy-Storage Components

For the systems of FIG. 2A through FIG. 6A, the recovery of energy with the correct polarity into the first energy-storage component (so that the energy is available for the start of the next cycle) does not flow current through or back through the load 120. For example, the alternate circuit path 150 diverts current flow around the load to invert the polarity of voltage on the energy-storage component 150 in some cases. For the systems of FIG. 7A through FIG. 9A, current can flow back through or through the load to recover energy with the correct polarity into one or more first energy-storage components. FIG. 1A is an example system where current flowing during the inversion stage flows back through the load 120 before flowing into the alternate circuit path 150. Flowing current through or back through the load as part of the energy-recovery process can be beneficial when a useful operation can be performed by the system with this secondary flow of current. Further, the flow or backflow of secondary current through the load can eliminate some system components (e.g., at least one inductor).

A simplified circuit is depicted in FIG. 7A for another system 700 that can perform energy recovery without using a second inductor and by flowing secondary current during recovery through the same load and in the same direction. The system 700 comprises two energy-storage components (depicted as capacitors C1, C2) that are connectable to either side of the load 120 with directional switches SW2, SW3. The system further includes diodes D2, D3 connected to either side of the load 120 in a recovery circuit path 750. There are two single pole, double throw switches SW1, SW4 connected in the circuit to charge the energy-storage components in a first position and discharge the energy-storage components in a second position. Other switching and supply configurations can be used in other implementations of the system.

During example operation, the energy-storage components may be charged oppositely with two supplies V1, V4, as depicted in FIG. 7A. After charging the energy-storage components C1, C2 to their initial voltages, the power supplies are disconnected and switches SW1, SW4 are moved to their second position. Current and energy are then delivered to the load via diode D4 and diode D1. As the voltages fall on the energy-storage components C1, C2 and rise across the inner diodes D2, D3, these two diodes will go into conduction and crowbar current through the load diverting some of the current (approximately one-half in the example circuit) back to the energy-storage component from which it came. At a later time, the directional switches SW2, SW3 open (e.g., using forced commutation). When switches SW2, SW3 open, current flowing in the inductor and energy stored in the inductor continue to drive current in the recovery circuit path 750, restoring the energy-storage components C1, C2 to their initial polarity at the start of the cycle. For proper circuit operation, a freewheeling diode may not be placed across the load 120. In some cases, the values of C1 and C2 may be between 10 mF and 10 F for a load 120 having an inductance between 5 nanohenries and 100 nanohenries, though higher or lower values as described above in connection with FIG. 4A may be used.

With a reduced current flow through the directional switches SW2, SW3 when diodes D2, D3 go into conduction can make forced commutation of an SCR more tenable. In some implementations, the directional switches SW2, SW3 can be implemented with IGCTs instead of SCRs.

The system 700 of FIG. 7A has some advantageous features. Like the systems of FIG. 5A and FIG. 6A, the polarities of initial voltages on the energy-storage components are not reversed during an operational cycle. Further, the system 700 does not require a blocking switch to block current from a circuit path. Also, the system does not require a recovery inductor L2 and separate inversion stage during each cycle. Recovery of energy into the same energy-storage components with the correct polarity begins to occur at the peak of the current delivered to the load during the delivery and recovery stage of operation and continues until the forward current through the load terminates. There is no inversion stage that follows the delivery and recovery stage. Thus, at the end of forward current flow through the load, the energy-storage components have recovered energy with the correct voltage polarity and are ready for the start of the following cycle. Consequently, the system may be run at a higher repetition rate.

The system configuration also makes efficient use of the capacitors C1 and C2 when used as energy-storage components. For example, high voltage can be split across the two capacitors to obtain a same voltage across the load compared to a scenario where a single capacitor handles the full voltage applied across the load. The system of FIG. 7A can also allow for a “flat top” of current until the directional switches are opened, at which time all of the remaining energy flows through the diodes and is recovered. This flat top or current holding feature may be useful for some applications. FIG. 7B and FIG. 7C depict simulated voltage and current waveforms, respectively, for components of the circuit of FIG. 7A.

FIG. 7D depicts a simplified circuit for a variation of the system of FIG. 7A where the supply circuitry is omitted. Diode D2 is replaced with a directional switch SW5 and diode D3 is replace with a directional switch SW6. FIG. 7E and FIG. 7F depict simulated voltage and current waveforms, respectively, for components of the circuit of FIG. 7D. For this implementation, the directional switches SW2, SW3 are closed to initially discharge the energy-storage components and reverse their polarity. Switches SW2, SW3 can then open and directional switches SW5, SW6 close to pass a second pulse of current in a forward direction through the load and invert the voltage polarity on the energy-storage components C1, C2.

FIG. 8A depicts a circuit for another electrical system 800 that performs energy recovery and operates with repeated cycles. In this system, there are two loads L1a, L1b which can be portions of the same load. For example, each load L1a, L1b can be a portion of an electromagnetic coil, such as one segment of a multi-segmented electromagnetic coil as described in U.S. Provisional Patent Application No. 63/210,416, titled “Inertially-Damped Segmented Coils for Generating High Magnetic Fields,” filed Jun. 14, 2021, which application is incorporated by reference herein.

Initially, the power supply Vₛᵤₚₚ charges both energy-storage components C1a, C1b. Then, directional switch SW2 closes to deliver energy stored in the two capacitors through the load inductors L1a, L1b. Switch SW2 remains closed while current continues to flow through the inductors, reversing the polarity of voltage across the energy-storage components C1a, C1b. When the current through switch SW2 falls below its holding current, the switch SW2 can self-commutate and open. With the rising reverse polarity on the energy-storage components C1a, C1b, the directional switch SW3 can activate and conduct current through inductor L2. The flow of current through L2 can invert the voltage polarity on the two energy-storage components C1a, C1b back to their initial polarity at the start of the cycle. Because the inductance of L2 is larger than the inductances of L1a and L1b, the recovery currents flow for a longer duration of time, as can be seen in FIG. 8C. FIG. 8B and FIG. 8C depict simulated voltage and current waveforms, respectively, for components of the circuit of FIG. 8A.

FIG. 8D depicts a simplified circuit for a variation of the system of FIG. 8A. The supply circuitry is omitted and initial charging of the energy-storage components C1a, C1b for the start of a cycle are indicated in the drawing. Like the system of FIG. 8A, the system 802 of FIG. 8D is configured to drive two portions of a load L_Load1, L_load2 with two energy-storage components C1a, C1b (e.g., such as two segmented coils of a single-turn coil). The directional switch SW3 and recovery inductor L2 are replaced with a diode D1. The use of the diode prevents the voltage from reversing on the energy storage components. The behavior of the circuit is quite different from that for the circuit of FIG. 8A. Waveforms for each cycle for the circuit of FIG. 8D are plotted in FIG. 8E (voltage) and FIG. 8F (current).

FIG. 8G depicts a simplified circuit for a variation of the system of FIG. 8A. The supply circuitry is omitted and initial charging of the energy-storage components C1a, C1b for the start of a cycle are indicated in FIG. 8G. The system 804 of FIG. 8G removes the recovery inductor L2. As can be seen from the voltage and current waveforms in FIG. 8H and FIG. 8I, respectively, the behavior of the circuit is similar to that for FIG. 8A, except that the inversion current (second pulse) is of the same amplitude and duration and the initial delivery of current to the loads L1a, L1b.

FIG. 9A depicts a circuit for an electrical system 900 that performs energy recovery and operates with repeated cycles. The system 900 is similar to that of FIG. 8G, except that a snubber circuit has been placed across switch SW3 and directional switch SW2 is replaced with a diode D2. The inductor L3, capacitor C3, and resistor R2 comprise the snubber circuit which may help protect the supply circuitry and/or the switch SW3.

After energy-storage components C1a, C1b are charged, switch SW1 opens and switch SW3 closes so that current and energy can flow to the loads L1a, L1b and reduce the voltage across the energy-storage components and also reduce the reverse voltage across the diode D2. At a later time, diode D2 will go into conduction and crowbar current through the loads L1a, L1b and through the directional switch SW3. This can provide a flat top of current through the loads, as depicted in FIG. 9C. At a later time, switch SW3 can be opened to recover energy into the energy-storage components C1a, C1b with the correct polarity for the start of the next cycle. Flowing current and energy remaining in the inductive loads L1a, L1b can recharge the capacitors C2, C1 for the next cycle. FIG. 9B and FIG. 9C depict simulated voltage and current waveforms, respectively, for components of the circuit of FIG. 9A.

2.2d Energy-Recovery Circuits with Transformers

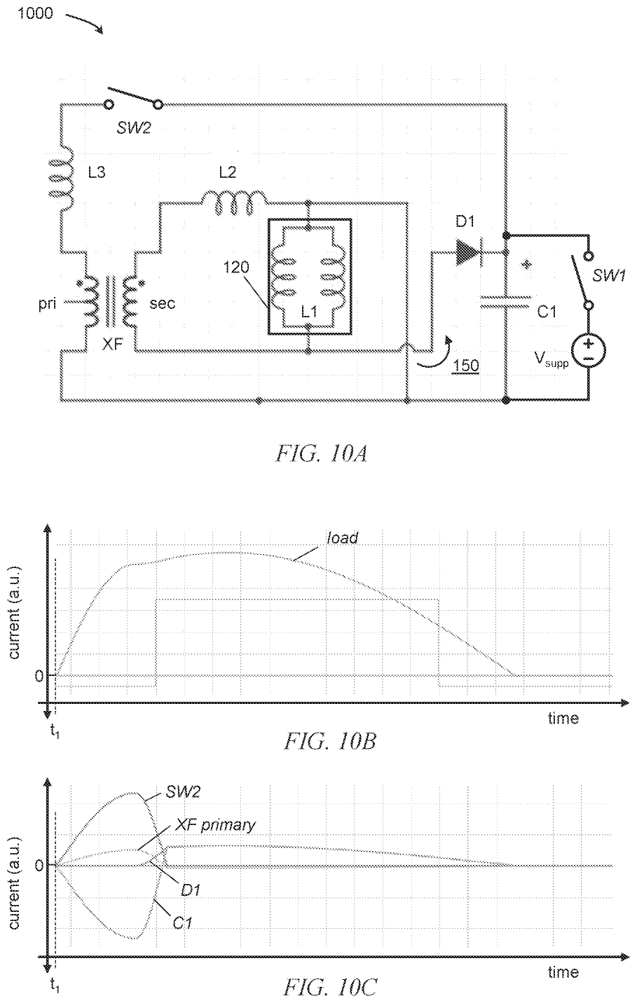

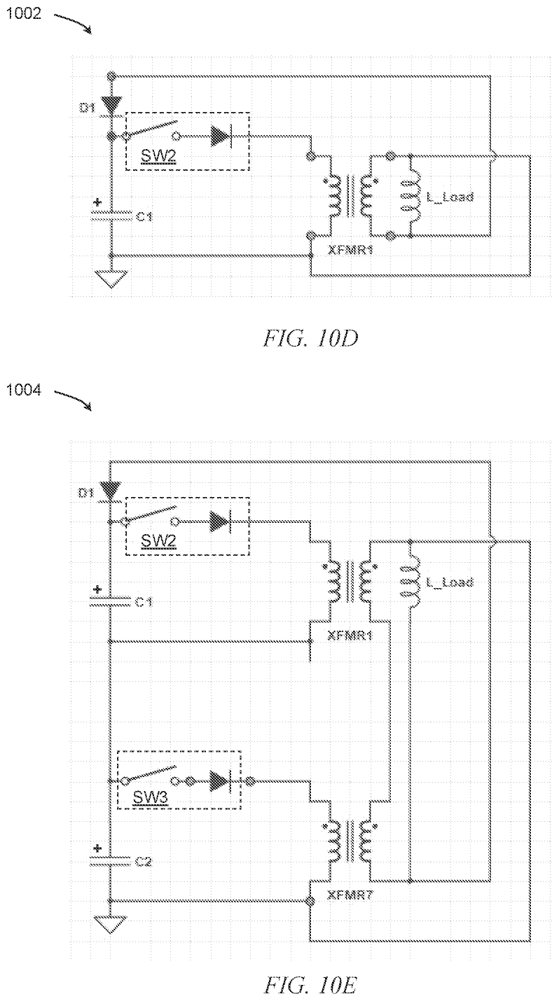

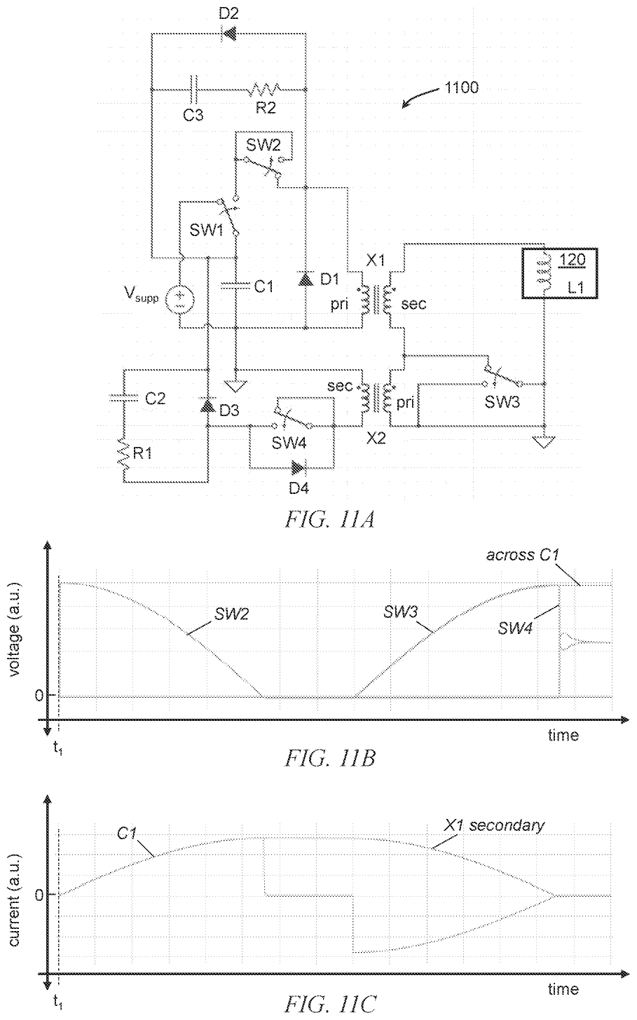

Isolating the load from the switching and capacitor bank through a transformer offers additional advantages when it comes to conserving energy and dealing with the challenges of series switching. The energy-recovery circuits of FIG. 10A through FIG. 13A include transformers that can provide such isolation as well as participate in energy recovery.

FIG. 10A depicts a circuit for an electrical system 1000 that includes an isolating transformer and performs energy recovery and operates with repeated cycles. Switch SW2 may be SCR-type switch. After energy-storage component C1 is initially charged and switch SW1 opens, switch SW2 closes energizing the transformer XF which drives current in the primary winding. In response, the transformer drives current through the secondary winding and through the load 120. As the voltage across the energy-storage component C1 falls and current in the primary of the transformer falls to zero, switch SW2 can open. Simultaneously, forward voltage across diode D1 increases forcing the diode into conduction. Current can then flow from the load 120 through diode D1 to recharge the energy-storage component C1 with a correct polarity for the start of the next cycle. FIG. 10B and FIG. 10C depict simulated current waveforms for components of the circuit of FIG. 10A.

FIG. 10D is a simplified circuit for a variation of the circuit of FIG. 10A. The supply circuitry is omitted. Switch SW2 and inductor L3 in the circuit of FIG. 10A are replaced with the directional switch SW2 in FIG. 10D. The parallel inductors of the load are simplified into one inductor of equivalent inductance. Inductor L2 is also removed from the secondary circuit off the transformer. The behavior of the system 1002 of FIG. 10D is nearly the same as that for FIG. 10A and need not be described again. The removal of inductors L3 and L2 shortens the rise time of current through the transformer's primary and secondary windings.

FIG. 10E is a simplified circuit for a variation of the system of FIG. 10D. Additional windings can be added to a transformer to utilize additional energy-storage elements C2 for driving current through the load L_Load. In operation, the directional switches SW2, SW3 would close simultaneously at a first time and open simultaneously at a later time.

For any of the circuits of FIG. 10A, FIG. 10D, and FIG. 10E, the diode D1 can be replaced with a directional switch. The directional switch can be operated to provide a full half sine of current through the load L_Load, which would result in reversing the voltage polarity on the energy-storage component C1 (which does not occur with these three circuits). Polarity inversion could then be executed subsequently when desired by closing the switch and opening switches SW2 and SW3 for the implementation of FIG. 10E.

FIG. 11A depicts a circuit for an electrical system 1100 that performs energy recovery and operates with repeated cycles. The system can use one or more transformers X1, X2 to isolate the load L1 from supply circuitry and to recover energy provided to the load L1 during each cycle. Although the system may operate with two separate transformers X1, X2, as illustrated, in some cases a single transformer core with three windings may be used instead. After energy-storage component C1 is initially charged, single pole, double throw (SPDT) switch SW1 toggles and SPDT switches SW2, SW3, and SW4 toggle so that current flows through the two transformers, creating current flow through the load L1. At a later time, switch SW2 and SW3 toggle while switch SW4 remains closed. Energy stored in the load and first transformer can drive current in the primary of the first transformer to recharge energy-storage component C1 through diodes D1 and D2 which go into conduction. Energy stored in the second transformer X2 can drive current in the secondary of that transformer to charge energy-storage component C1 through diode D3.

In system 1100, the load is coupled to the energy-storage component C1 through the transformer X1. This coupling and use of diodes D1, D2, D3 can prevent voltage reversal on the energy-storage component C1. Additionally, the coupling through the transformer allows for a voltage step up which, in turn, allows for parallel operation of switches, as opposed to series operation. Parallel operation of switches can be advantageous, because series operation of switches is challenging and can have more potential failure modes. For example, to obtain any current flow through series connected switches, all the switches must turn on simultaneously. For parallel-connected switches, current will begin flowing when any switch turns on. During turn-off of series-connected switches, all should turn off simultaneously to avoid all the reverse blocking voltage being applied across the few or one that initially turns off. For parallel connected switches, the reverse blocking voltage does not appear until all switches have turned off. FIG. 11B and FIG. 11C depict simulated voltage and current waveforms, respectively, for components of the circuit of FIG. 11A.

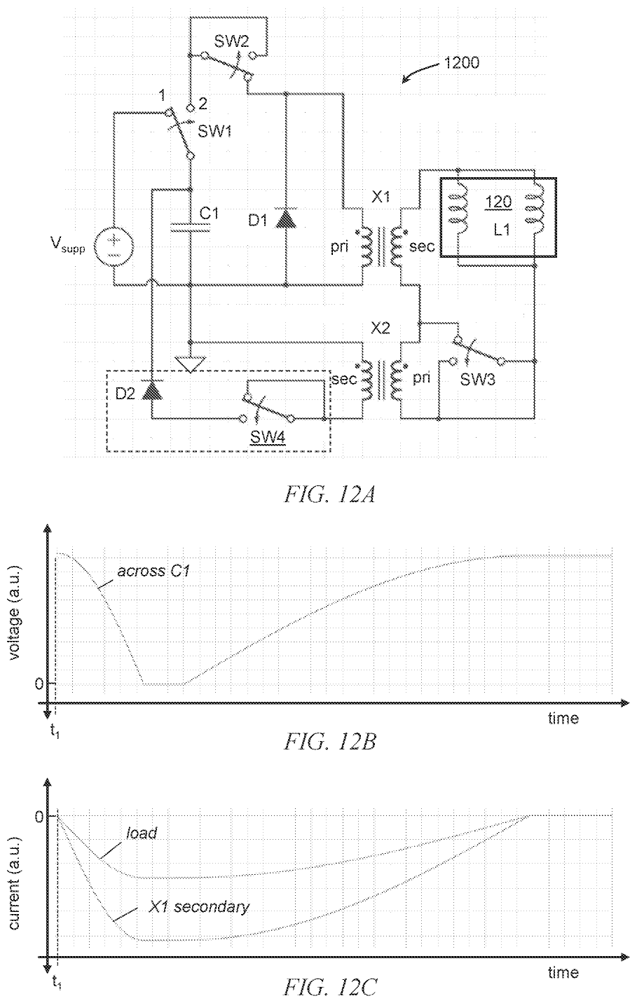

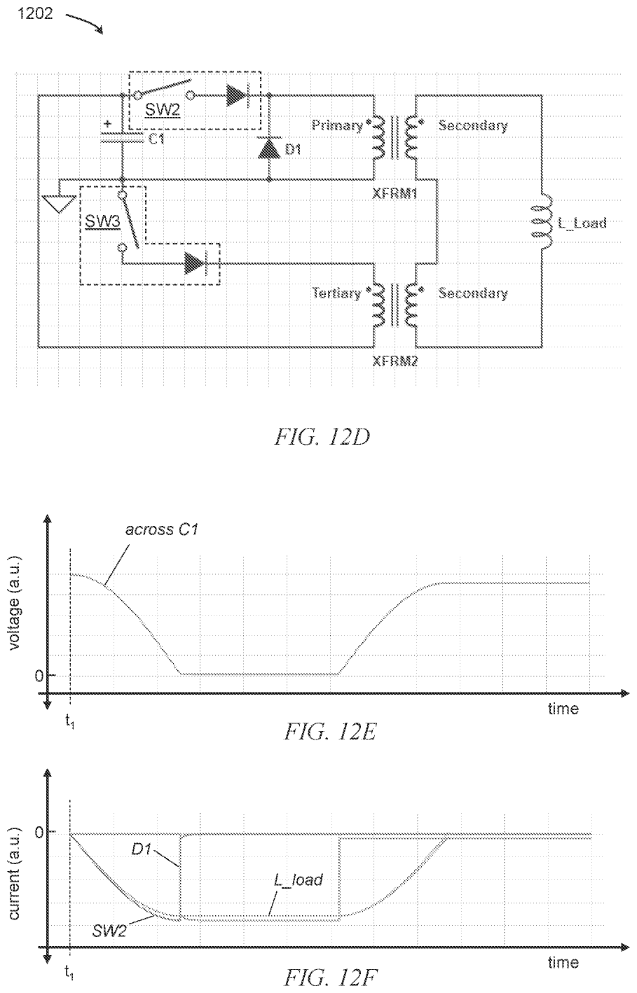

FIG. 12A depicts a circuit for an electrical system 1200 that performs energy recovery and operates with repeated cycles. The system uses transformers to store and recover energy provided to the load 120 and may also operate with two separate two-winding transformers as shown or with a single three-winding transformer. After initially charging energy-storage component C1, switch SW1 toggles from a first position to a second position (indicated by numbers 1 and 2, respectively) while switch SW3 remains in its first position as illustrated. Energy from the energy-storage component C1 then energizes the first transformer X1 driving current through the load L1. The second transformer X2 is bypassed. At a later time, switch SW2 opens and switches SW3 and SW4 toggle to their second position. Energy remaining in the first transformer X1 and load 120 energizes the second transformer X2 to drive current in its secondary winding which aids in recharging the energy-storage component C1 for the next cycle. FIG. 12B and FIG. 12C depict simulated voltage and current waveforms, respectively, for components of the circuit of FIG. 12A.

FIG. 12D is a simplified circuit for a variation of the system of FIG. 12A. Multiple primaries (depicted as a primary and tertiary in the drawing) can be added to increase the effective voltage of the secondary while keeping the voltage on directional switches SW2, SW3 low. Keeping a low voltage on the switches can be beneficial when running several switches in series to achieve the correct voltage isolation. In this system 1202, transformer XFRM1 and transformer XFRM2 are part of a three-winding transformer that share magnetic flux between the two sets of windings. When directional switch SW2 closes, it drives current through the load L_Load via the transformer XFRM1 and the current subsequently crowbars through diode D1. After the directional switch SW2 opens, the directional switch SW3 can close to drain remaining current and energy out of the secondary leg and load L_Load to bring the energy-storage component C1 back to its initial voltage polarity. FIG. 12E and FIG. 12F depict simulated voltage and current waveforms, respectively, for components of the circuit of FIG. 12D.

FIG. 13A depicts a circuit for an electrical system 1300 that performs energy recovery and operates with repeated cycles. After energy-storage component C1 is initially charged, a SPDT switch SW1 toggles to a second position and the directional switch SW2 activates to energize the transformer X1 which drives current in its secondary winding and through the load 120. As the voltage across the energy-storage component C1 falls and begins to reverse, the diode D2 goes into conduction. The current through the directional switch SW2 falls and the switch opens. Current flowing in the load L1 and the transformer X1 and energy remaining in these components drive current through diode D2 to recharge the energy-storage component C1 with a correct polarity for the start of the next cycle. FIG. 13B and FIG. 13C depict simulated voltage and current waveforms, respectively, for components of the circuit of FIG. 13A.

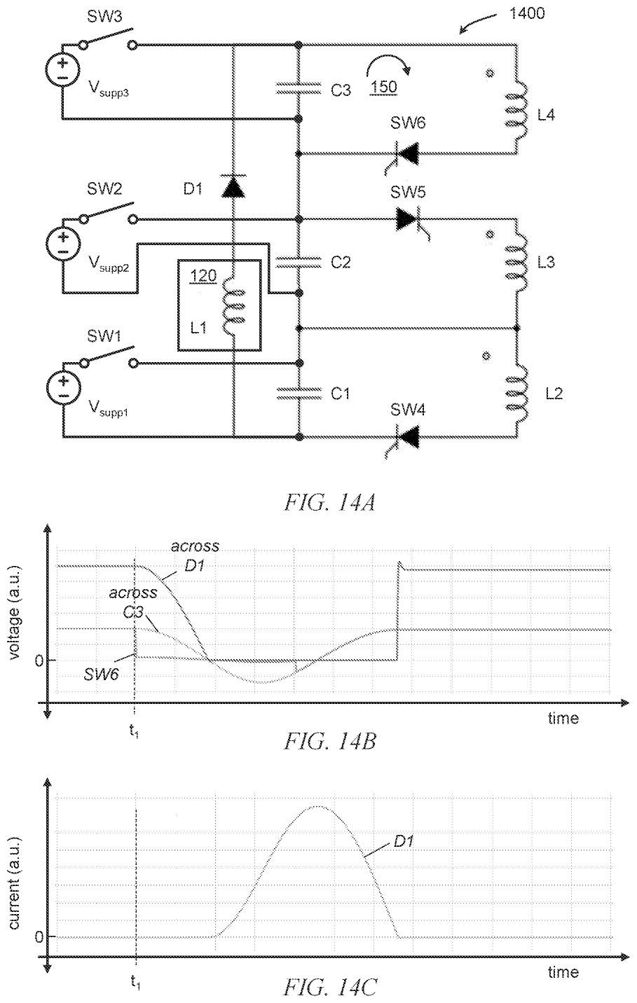

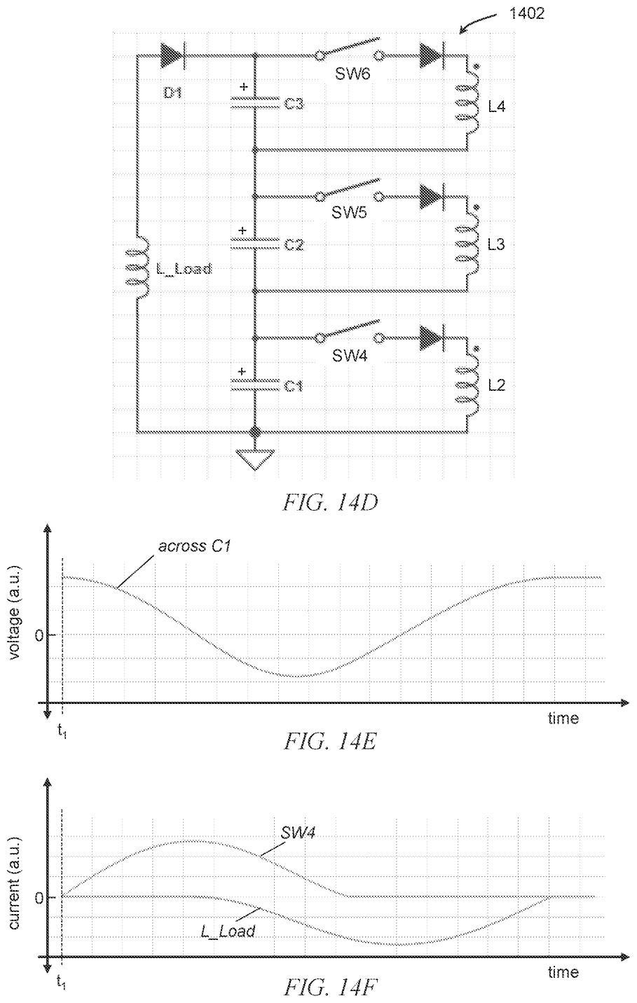

FIG. 14A depicts a circuit for an electrical system 1400 that performs energy recovery and operates with repeated cycles. Although the circuit does not include a transformer, the inductors L2, L3, L4 can share flux (e.g., be wound around a same magnetic circuit). The system 1400 includes three voltage supplies Vₛᵤₚₚ₁, Vₛᵤₚₚ₂, Vₛᵤₚₚ₃ that are arranged to charge three energy-storage components C1, C2, C3. The energy-storage components are connected in series to increase the voltage applied to the load. Directional switches SW4, SW5, SW6 (depicted as SCRs) can activate simultaneously to drive current through the load 120. When voltage on the capacitors begins to reverse, diode D1 can go into conduction allowing current to flow through the load L1.

In the circuit of the system 1400, energy from the capacitors is first transferred to inductors L2, L3, L4 and then to the load 120. A pulse of current will flow through the load and diminish, causing the SCRs to self-commutate and open. Current flowing in the load and energy remaining there will drive current into the energy-storage components recharging them with the correct polarity for the next cycle. For correction action of the diode D1 and directional switches SW4, SW5, SW6, the inductance of the load should be 2 to 3 times the sum of inductances for the inductors L2, L3, L4.

The system 1400 can also allow for the parallel, as opposed to the more difficult series, operation of switch components SW4, SW5, SW6 to achieve a required speed/voltage on the load. FIG. 14B and FIG. 14C depict simulated voltage and current waveforms, respectively, for components of the circuit of FIG. 14A.

FIG. 14D depicts a simplified circuit for the system of FIG. 14A. The supply circuitry is omitted from the system 1402. Operation of the system 1402 is described above in connection with FIG. 14A. FIG. 14E and FIG. 14F depict simulated voltage and current waveforms, respectively, for components of the circuit of FIG. 14D.

2.2e Energy-Recovery Circuits that Avoid Voltage Reversal on Energy-Storage Components

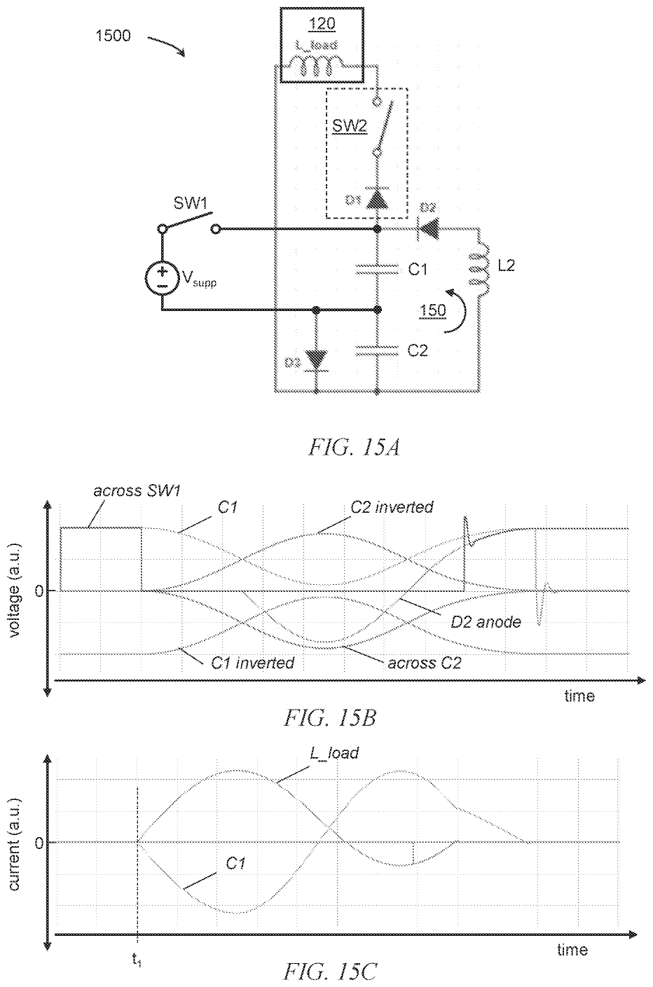

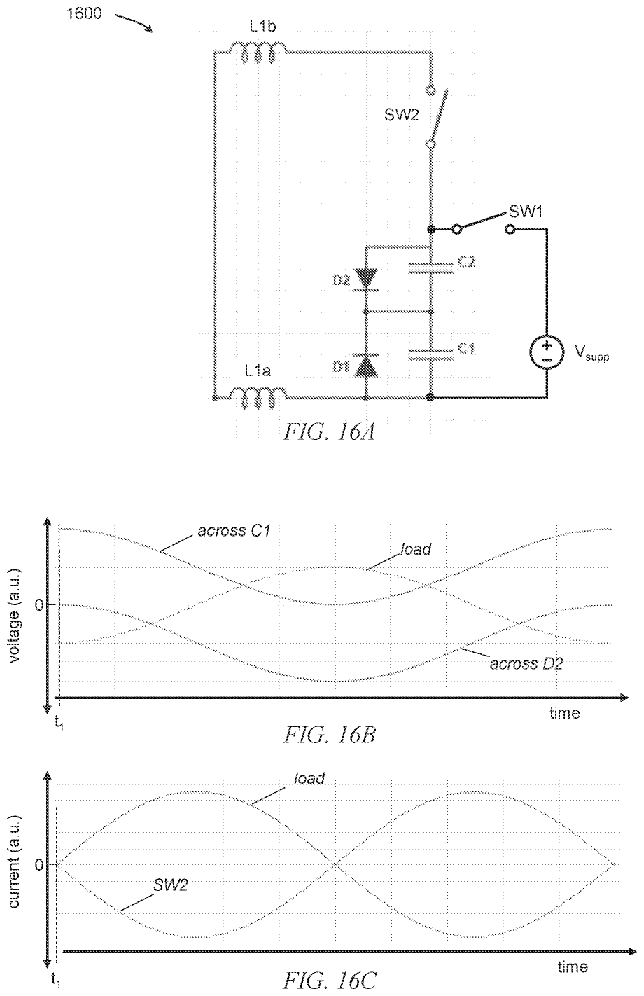

As described above, it can be beneficial to avoid voltage reversal on energy-storage components during an operational cycle of an energy-recovery system. Avoiding voltage reversal can reduce the size and cost of energy-storage components, such as capacitors. The circuits of FIG. 15A and FIG. 16A include series connected capacitors for energy-storage components. The capacitors are connected in the circuits in a way to avoid voltage reversal on the capacitors. Such a configuration may also avoid voltage reversal on some system switches.

Some of the circuits described above include other ways to avoid voltage reversal on energy-storage components. Some circuits (such as for the systems of FIG. 5A, FIG. 5D, and FIG. 6A) employ a second energy-storage component (capacitor C2) connected to the load to temporarily store energy from the load, thereby avoiding reversing the polarity of the first energy-storage component C1. Current and energy can be transferred from the second energy storage component to the first energy-storage component to charge the first energy-storage component with a correct polarity for the start of the next cycle.

Another approach is to use at least one diode that goes into conduction to prevent substantial voltage reversal across the energy-storage components. Examples of this approach are described above in connection with the systems of FIG. 7A, FIG. 8D, FIG. 9A, FIG. 10A, FIG. 10D, FIG. 10E, FIG. 11A, FIG. 12A, FIG. 12D, and FIG. 13A.

FIG. 15A depicts a circuit for another electrical system 1500 that performs energy recovery and operates with repeated cycles. The system is similar to that of FIG. 2A, except that two energy-storage components (capacitors C1, C2) are connected in series to store and participate in recovering system energy. For the system 200 of FIG. 2A, voltage across the terminals of the directional switch SW2 can reverse as the energy-storage component C1 reverses its charge. This may not be desirable for some switches. Adding a second capacitor C2 as in the system 1500 of FIG. 15A can avoid such a voltage reversal across the capacitor C1 and across the directional switch SW2.

During operation of the system 1500, the first energy-storage component C1 only charges to one polarity at the terminal connected to directional switch SW2. When the directional switch activates, the capacitor discharges into the load 120. Current passing through the load begins accumulating in the second energy-storage component C2, until diode D2 goes into conduction. When diode D2 conducts, current from the second energy-storage component C2 recharges the first energy-storage component with its initial polarity. Both energy-storage components charge alternately to only one polarity during each cycle. Such as system may allow the use of large electrolytic capacitors for C1 and C2. FIG. 15B and FIG. 15C depict simulated voltage and current waveforms, respectively, for components of the circuit of FIG. 15A.

FIG. 16A depicts a circuit for another electrical system 1600 that performs energy recovery and operates with repeated cycles. The circuit includes two capacitors C1, C2 for energy storage and energy recovery. The system may have one or two loads L1a, L1b. Two loads may be two segments of a segmented coil, as described above in connection with the system of FIG. 8A. When switch SW1 closes, the supply voltage is applied across both capacitors, but energy storage is primarily in capacitor C1 due to the diode D2 across capacitor C2. Switch SW1 can then open and switch SW2 close. Current may then flow through the load(s) L1a, L2a to transfer energy from capacitor C1 to capacitor C2. Energy can then transfer back to capacitor C1 through the load(s) to recharge C1 with a correct polarity for the start of the next cycle. For this circuit, the energy recovery path (after the initial energy is delivered to the load(s)) is the same path as the energy-delivery path to the load(s), similar to the system of FIG. 1A. This circuit may be used for loads that are connected in parallel or series. FIG. 16B and FIG. 16C depict simulated voltage and current waveforms, respectively, for components of the circuit of FIG. 16A. In FIG. 16C, the current through the switch SW2 is plotted with opposite polarity so that it is visible.

### 2.3 Directional Switches for Energy-Recovery Circuits

FIG. 17A through FIG. 17F depict schematics for directional switching circuits that can be used in the energy-recovery circuits for the systems of FIG. 1A through FIG. 16A and in the circuits shown in FIG. 18A through FIG. 22. The particular switch implementation can depend upon the circuit application (e.g., the voltage and/or current level(s) that are being switched on and off and blocked). These directional switches may be referred to as diode-assisted self-commutating switches.

For high voltage and/or high current applications, the directional switches of FIG. 17A through FIG. 17C and FIG. 17F may be used. For low voltage, low current applications, the directional switches of FIG. 17D and FIG. 17E may be used. Additionally, a single SCR can be used as a directional switch in low voltage, low current applications. Although the directional switches are depicted with SCRs as switching elements, directional switches may be formed with other switching elements, such as IGBTs, IGCTs, GTOs, etc. mentioned above. Such switches may or may not be self-commutating. When not self-commutating, the switches may be forced on and/or off by control signals applied to control terminal of the switches, for example. In some cases where long time scales are involved, mechanical switches can be used for switching elements of the directional switches.

An advantage of using semiconductor-based switches is that fast switching times can be possible. In some implementations, the directional switches described herein can turn on (from 10% on to 90% on) in a time between 0.25 microsecond and 1 millisecond, though shorter or longer turn-on times may be possible. In some cases, the turn-on time is between 0.25 microsecond and 250 microseconds, between 0.25 microsecond and 150 microseconds, or between 0.25 microsecond and 50 microseconds. In some implementations, the directional switches described herein can turn off (from 90% on to 10% on) in a time between 0.25 microsecond and 1 millisecond, though shorter or longer turn-off times may be possible. In some cases, the turn-off time is between 0.25 microsecond and 250 microseconds, between 0.25 microsecond and 150 microseconds, or between 0.25 microsecond and 50 microseconds. Accordingly, the switches can support pulse durations (FWHM) between 1 microsecond and 5 milliseconds or longer. In some implementations, the pulse duration is between 1 microsecond and 250 microseconds. The directional switches can also handle high peak powers (e.g., up to a value between 0.5×10⁹ watts and 0.1×10⁹ watts for the above pulse durations). Higher peak powers may be possible for some of the directional switches.

As described above in connection with FIG. 1A, the directional switches use at least one forward diode (D3 or D1 in FIG. 17A through FIG. 17E) to assist in turn-off of the switch. The forward diode(s) can absorb most of the total recovery energy of the switch and dissipate heat generated by the absorbed recovery energy in addition to dropping a majority of reverse voltage applied across the switch in an off state. The inclusion of the forward diode(s) can allow slower, less costly switching elements (e.g., SCRs having turn-off times in excess of 50 microseconds, in excess of 100 microseconds, in excess of 200 microseconds, in excess of 500 microseconds, in excess of 1 millisecond, or even longer turn-off times) to be used in the directional switching circuits that can carry larges amounts of currents at high voltages (e.g, up to 1,000,000 amps at 1,000 volts or more). Reliable operation of the switch is due in part to the forward diode(s) having a shorter turn-off time than the switching element(s), such that the forward diode(s) goes (or go) into blocking mode before the switching element(s) go into blocking mode. The inclusion of the forward diode(s) can allow the switching element(s) to be operated in forward mode at higher currents and voltages than would normally be possible for the switch to block when the switch commutates. Without the forward diode(s), the switching element(s) would be damaged when commutated at such power levels.

As an example where one or more SCRs are used as switching elements, the recovery energy dissipated in the reverse diode(s) and SCR(s) can raise their temperature. With the reverse diode(s) absorbing 98% of the recovery energy, the temperature of the reverse diode(s) can increase by more than 250° C. With the SCR(s) absorbing 2% of the recovery energy, the temperature of the SCR(s) can increase by less than 5° C. Generally, an SCR cannot be operated at as high a temperature as a diode. For example, a diode may operate reliably under pulsed operation at temperatures up to 400° C., whereas an SCR may only be able to operate up to 150° C. Without the forward diode(s) in the switching circuit, the temperature of the SCR would increase from an ambient temperature over its operating temperature limit and most likely damage the SCR. With the forward diode(s), the SCR could be operated within 10° C. of its temperature limit under forward conduction and still reliable turn off and switch large currents and voltages under conditions that would otherwise damage the SCR.

Further, the inclusion of the forward diode(s) D1, D3 can allow slower, smaller, and significantly less costly, SCRs to be used to switch large currents and voltages. A slow SCR may be an SCR having a turn-off time greater than 30 microseconds, greater than 50 microseconds, greater than 100 microsecond, greater than 200 microseconds, greater than 500 microseconds, or even greater than 1 millisecond in some cases. Use of the slower switching element(s) is possible because of the faster turn-off of the forward diode(s) and their ability to handle the majority of the recovery energy imposed on the switch when the switch goes into blocking mode.

FIG. 17A depicts an example of a directional switch 1710 used for the system 100 of FIG. 1A. Two such directional switches 110, 130 are used in that system to deliver and receive current to and from the load 120. The arrangement of the two switches 110, 130 forms a bidirectional switch, like the bidirectional switch 1760 depicted in FIG. 17F, which uses fewer SCRs and additional forward diodes D1 and reverse diodes D2 per SCR.

The directional switch 1720 of FIG. 17B uses one reverse diode D2 for each SCR in the switch. Using additional reverse diodes D2 can distribute power dissipation and voltage drop associated with any reverse leakage current through the switch across multiple reverse diodes D2 instead of a single diode. This can be beneficial for high voltage systems. The directional switch also includes multiple forward diodes D1. Forward diodes can be stacked as needed to handle any reverse voltage across the directional switch 1720 when the switch turns off. Using multiple forward diodes D1 can distribute the high reverse voltage drop and power dissipation associated with reverse leakage current across the multiple diodes. Fewer switching elements (e.g., SCRs) may be used when multiple forward diodes D1 and multiple reverse diodes D2 are used. In some cases, a single forward diode D1 that can handle the entire voltage drop and power dissipation for a high voltage, high current application may not be available.

In FIG. 17B, the forward diodes D1 are connected to the cathode side of the switch's switching elements, whereas in FIG. 17A the forward diode D3 is connected to the anode side of the switch's switching elements. Either arrangement of the forward diode is suitable for operation of the switch. In some cases, forward diodes can be located on both the anode and cathode sides of the switching elements in a directional switch.

The directional switch 1730 of FIG. 17C implements switching elements (e.g., SCRs) in parallel. A parallel arrangement of switching elements can be used to handle large forward currents. Each switching element can have a balancing resistor (as shown) such that the switches all turn on at a same time under forward bias. There can be one reverse diode D2 (as shown) or multiple reverse diodes to short all switching elements under reverse bias. There can be one or multiple forward diodes D1 connected to one or both sides of the directional switch.

FIG. 17D depicts a directional switch 1740 that may be implemented in lower voltage systems (e.g., less than 5,000 volts). A single switching element (SCR in this example) may be used with one or more forward diodes D1 connected in series to help protect the switching element under reverse bias, as described above. The diode can block most of the reverse bias and leakage current while the switching element transitions from forward conduction to its non-conducting state. The directional switch 1750 of FIG. 17E adds a reverse diode D2 for additional protection of the switching element, as described above.

FIG. 17F illustrates a bidirectional switch 1760 that comprises two directional switches (like those shown in FIG. 17B) connected in parallel in opposite directions. Voltage applied across the switch of a first polarity that exceeds a first turn-on voltage for a first one of the directional switches (e.g., the switch containing switching elements SCR1) will activate the switching elements in the first directional switch allowing current flow through that directional switch until the current drops below the holding current for the first directional switch. Voltage applied across the switch of a second, opposite polarity that exceeds a second turn-on voltage for the second directional switch (e.g., the switch containing switching elements SCR2) will activate the switching elements in the second directional switch allowing current flow in an opposite direction through that directional switch until the current drops below the holding current for the second directional switch. The two directional switches may have identical components for some implementations or may have some or all different components in other implementations. For example, at least the switching elements SCR2 may be different from the switching elements SCR1 if it is desired to initiate conduction of current in the reverse direction at a different voltage than the voltage that will initiate current flow in the forward direction through the bidirectional switch 1760. Having different switching elements can also allow the two directional switches to turn off at different holding current conditions.

The bidirectional switch can be employed is some of the above-described energy-recovery systems where current flow in both directions through the load or through another system component is used. For example, switch SW2 of the system 1600 of FIG. 16A can be implemented with a bidirectional switch.

### 2.4 Subcircuits for Energy-Recovery Systems

FIG. 18A through FIG. 20A depict subcircuits that can be used in the energy-recovery systems described above. The subcircuits may be added in combination to an energy-recovery system, some examples of which follow in FIG. 21 and FIG. 22.

FIG. 18A depicts a circuit 1800 for an electrical system that can operate with repeated cycles. The circuit 1800 is a subcircuit for the system 800 of FIG. 8A. The circuit 800 can deliver pulses of energy to two portions of a load L1a, L1b. Initially energy-storage components C1a and C1b are charged to deliver power to the load portions. Then, switches SW1a, SW1b open. Directional switch SW2 can then close so that current flows from the energy-storage components C1a, C1b through the portions of the load L1a, L1b. As described above, configuring two energy storage components to drive two portions of a load can double the voltage drop across the load for a given supply voltage Vₛᵤₚₚ. FIG. 18B and FIG. 18C depict simulated voltage and current waveforms, respectively, for components of the circuit of FIG. 18A.

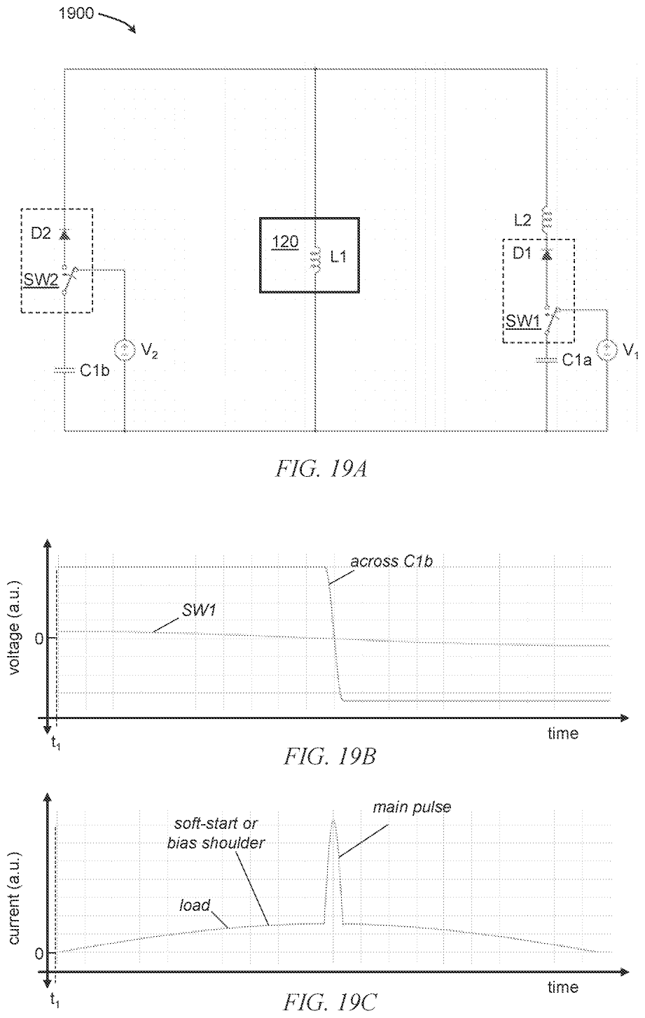

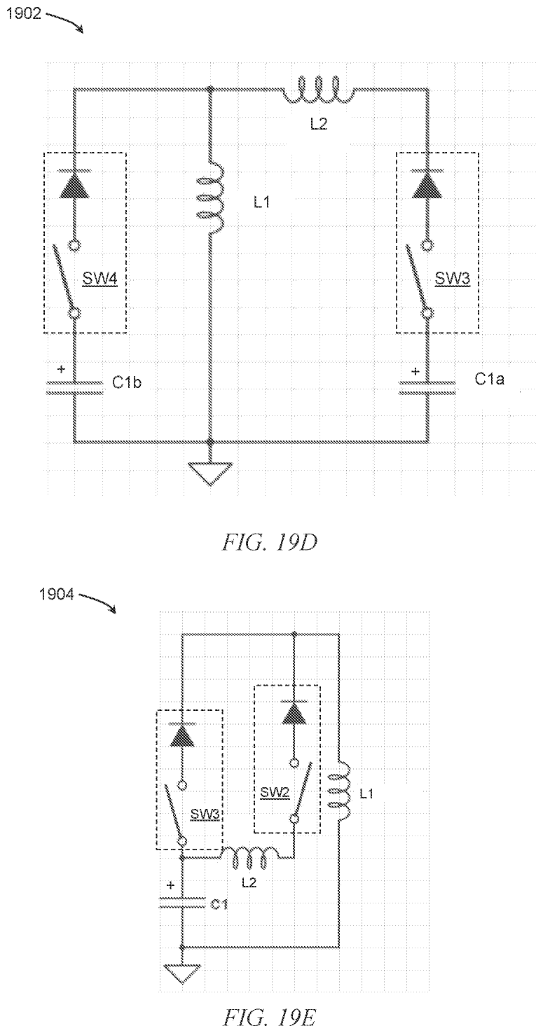

FIG. 19A depicts a circuit 1900 for an electrical system that can deliver energy at two different rates to a load from two energy-storage components C1a, C1b. In this implementation, directional switches are configured as single pole, double throw switches. These switches may comprise a mechanical switch or relay having one of its terminals connected to a diode D1 or D2. Two capacitors C1a, C1b are initially charged by two supplies V₁, V₂. The capacitors store and deliver energy to the load 120 at different times and at different rates to shape the pulse of current delivered to the load 120, as described above in connection with FIG. 4A and other circuits. After charging energy-storage components C1a, C1b, directional switch SW1 toggles to its second position to deliver energy from energy-storage component C1a to the load 120 through inductor L2 at a first slower rate of power delivery than is the case when switch SW2 closes. The choke inductor L2 can have an inductance at least twice the inductance of the load to slow the rate of initial energy delivery. The delivery of energy from energy-storage component Cia forms a soft-start shoulder or bias shoulder through the load 120. The shoulder can be seen, for example, in the current plots of FIG. 4D, FIG. 4E, FIG. 5C, and FIG. 19C.

At a later time, directional switch SW2 toggles to its second position to deliver energy from energy-storage component C1b. Since there is no inductor between energy-storage component C1b and the load 120, energy is delivered more quickly to the load providing a main pulse, as can be seen in the current waveform for the load in FIG. 19C. The main pulse may be used to execute a particular function by the load (e.g., acceleration of a particle to top speed). FIG. 19B and FIG. 19C depict simulated voltage and current waveforms, respectively, for components of the circuit of FIG. 19A.

The circuit 1902 of FIG. 19D is a simplified version of the circuit of FIG. 19A. The supplies are omitted and can connect through separate switches below the directional switches SW3, SW4. Another aspect of the switching circuits of FIG. 19A and FIG. 19D is that different supply voltages can be used for each energy-storage component and the supplies V₁, V₂ can be isolated from each other.

The simplified circuit 1904 of FIG. 19E is a variation of the circuit of FIG. 19D where a single energy-storage component is used to provide both the soft-start or bias shoulder and main pulse. This sub-circuit is present in the system of FIG. 4A, as described above, and need not be described again.

It will be appreciated for the circuits of FIG. 19A, FIG. 19D, and FIG. 19E that inductances in the circuit branch that contains the load L1 and in the circuit branch that contains the choke inductor L2 can be selected and/or changed (e.g., by adding inductors) to obtain desired pulse shapes of current applied to the load. For example, adding inductance to the circuit branch that contains the choke inductor L2 can broaden the soft-start or bias shoulder. Adding inductance to the circuit branch that contains the load L1 can broaden the main pulse. Further, additional energy-storage components and/or circuit branches with different inductors can be added to provide additional rates of energy delivery for pulse shaping.

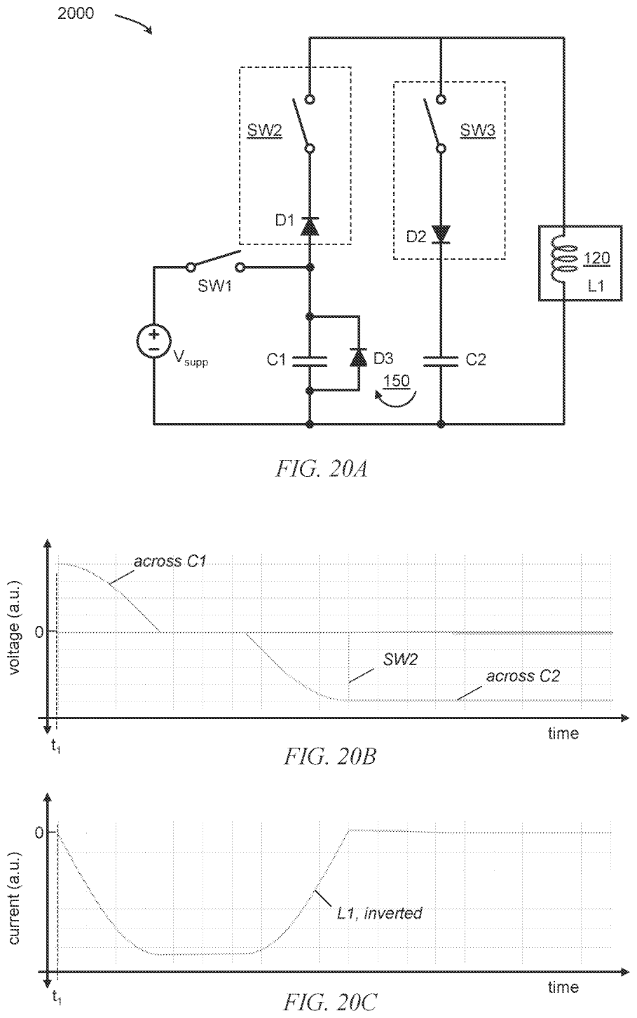

FIG. 20A depicts a circuit for an electrical system 2000 that can provide a flat-top current pulse. The system can also perform energy recovery and operate with repeated cycles. The circuit includes two energy-storage components C1, C2 for energy delivery and recovery. A diode D3 shunts one of the energy-storage components C1.

In operation, after charging energy-storage component C1, directional switch SW2 can close while directional switch SW3 remains open. Current will flow through the load 120 and force diode D3 into conduction. As a result, current peaks and circulates around the loop containing the load and diode D3. In some implementations, diode D3 can be replaced with a directional switch.

At a later time, switch SW2 can be opened (e.g., using forced commutation with an external control signal) while switch SW3 closes. Energy stored in the load 120 can then accumulate in energy-storage components C1 and C2. Directional switch can then be opened. At the start of the next cycle, recovered energy stored in energy-storage component C2 can add to energy stored in energy-storage component C1 via a bypass diode D3. FIG. 20B and FIG. 20C depict simulated voltage and current waveforms, respectively, for components of the circuit of FIG. 20A.

### 2.5 Combinations of Circuits in Energy-Recovery Systems

FIG. 21 depicts a circuit for an energy-recovery system 2100 that includes directional switches and a combination of features provided by subcircuits described in the preceding section. The system 2100 includes four directional switches SW2, SW3, SW4, SW5, a single energy-storage component C1, a load L1, and two inductors L2, L3. Directional switches SW2, SW3 and inductor are configured for providing a soft-start shoulder and main pulse to the load L1, as described above in connection with FIG. 19E. Directional switch SW4 is configured to shunt the energy-storage component C1 and hold current flow, providing a flat-top current pulse as described in connection with FIG. 20A. Directional switch SW5 and inductor L3 are configured for inversion of the voltage polarity on the energy-storage component C1.

In operation, switch SW1 opens after energy-storage component C1 is fully charged by supply Vₛᵤₚₚ. Directional switch SW2 can then activate (e.g., by a first trigger pulse to the SCRs' gates in the switch) to provide a soft-start current flow to the load L1. At a later time, directional switch SW3 can activate (e.g., by a second trigger pulse to the SCRs' gates in the switch) to provide a main current pulse to the load. At a peak current value through the load, directional switch SW4 can be activated (e.g., by a third trigger pulse applied to the SCRs' gates in the switch) to crowbar current around the energy-storage component C1 and hold current flow through the load L1. At a later time, directional switch can be opened (e.g., by forced commutation) after which energy can accumulate in energy-storage component C1. The accumulation of energy in energy-storage component C1 will reverse its voltage polarity compared to the start of the cycle. Directional switch SW5 can be activated (either by a trigger pulse or automatically as the voltage reverses on the energy-storage component C1) to flow current through inductor L3 (if present) and inductor L2, inverting the voltage polarity on the energy-storage component C1.

If a flat-top current pulse is not used, the directional switch SW4 can be removed from the system. An example of such a system is shown in FIG. 22. The illustration of the energy-recovery system 2200 is simplified and omits the supply circuitry. For this example, the load 120 includes some resistance R in addition to inductance. FIG. 22B and FIG. 22C depict simulated voltage and current waveforms, respectively, for components of the circuit of FIG. 22A. Other energy-recovery systems with different subcircuit combinations are also possible.

Energy-recovery circuits, systems, and related methods may be implemented in different configurations. Examples of such configurations are listed below.

(1) A circuit to deliver energy to a load in repeated cycles and recover a portion of the energy, the circuit comprising: an energy-storage component to receive energy from a voltage source or current source; a first switch to reversibly couple the energy-storage component to a load along a first circuit path, the first switch configured to attain a first state such that, when the first switch is in the first state during a first portion of a first cycle of the repeated cycles, forward current flows from the energy-storage component to the load; and a second switch to reversibly couple the energy-storage component to the load along a second circuit path, wherein the second circuit path is different, at least in part, from the first circuit path, the second switch configured to attain a first state such that, when the second switch is in the first state of the second switch during a second portion of the first cycle, energy from the load is returned to the energy-storage component such that at least a portion of the energy returned is available for a first portion of a second cycle of the repeated cycles that follows the first cycle.

(2) The circuit of configuration (1), wherein the first switch is configured to: switch up to one million amps of the current when in the first state of the first switch; block at least 1,000 volts when in a second state in which the forward current does not flow through the first switch; and turn off in 150 microseconds or less when transitioning between the first state of the first switch and the second state of the first switch.

(3) The circuit of configuration (1), wherein the circuit operates for 10,000 cycles or more without failure of the energy-storage component, the first switch, or the second switch.

(4) The circuit of any one of configurations (1) through (3), wherein the energy-storage component comprises a capacitor.

(5) The circuit of any one of configurations (1) through (4), wherein the capacitor has a value of capacitance in a range from 10 microfarads to 10 millifarads.

(6) The circuit of any one of configurations (1) through (5), further comprising the source, wherein the source is a voltage source of at least 1,000 volts.

(7) The circuit of any one of configurations (1) through (6), further comprising the load.

(8) The circuit of configuration (7), wherein the energy-storage component is a first energy-storage component and the load comprises a second energy-storage component.

(9) The circuit of configuration (8), wherein the second energy-storage component comprises an inductor.

(10) The circuit of configuration (8), wherein the second energy-storage component comprises an electromagnetic coil, the electromagnetic coil being a single-turn electromagnetic coil or a segmented electromagnetic coil.

(11) The circuit of configuration (10), wherein the electromagnetic coil has a value of inductance in a range from 1 microhenry to 100 microhenries.

(12) The circuit of configuration (8), wherein the first energy-storage component comprises a first capacitor and the second energy-storage component comprises a second capacitor.

(13) The circuit of any one of configurations (8) through (12), wherein the second circuit path includes a third energy-storage component.

(14) The circuit of configuration (13), wherein the third energy-storage component is common to the second circuit path and the first circuit path.

(15) The circuit of any one of configurations (1) through (14), wherein the first switch comprises at least one silicon-controlled rectifier.

(16) The circuit of configuration (15), further comprising a forward diode connected in series with the at least one silicon-controlled rectifier and arranged to: allow forward current flow through the at least one silicon-controlled rectifier; and block reverse current flow through the at least one silicon-controlled rectifier.

(17) The circuit of configuration (15) or (16), wherein a first turn-off time of the forward diode between forward conduction and reverse blocking is shorter than a second turn-off time of the at least one silicon-controlled rectifier.

(18) The circuit of any one of configurations (15) through (17), further comprising: a resistor connected in parallel with a silicon-controlled rectifier of the at least one silicon-controlled rectifier; and
a reverse diode connected in parallel with the at least one silicon-controlled rectifier to allow reverse current flow in a parallel circuit path around a circuit path containing the at least one silicon-controlled rectifier, the parallel circuit path containing the reverse diode.

(19) The circuit of any one of configurations (1) through (18), wherein the second switch comprises at least one silicon-controlled rectifier.

(20) The circuit of any one of configurations (1) through (19), wherein the energy-storage component is a first energy-storage component, the circuit further comprising: a second energy-storage component connected in series with the first switch; and a third switch to reversibly couple the first energy-storage component to the load along a third circuit path, the third switch configured to attain a first state such that, when the third switch is in the first state during the first portion of a first cycle of the repeated cycles, the forward current flows from the energy-storage component to the load more rapidly through the third circuit path than through the first circuit path.

(21) The circuit of any one of configurations (1) through (19), further comprising a third switch connected in a third circuit path to reversibly bypass the first energy-storage component and to circulate the forward current in a circuit loop through at least the first switch, the load, and the third switch for an interval of time to form a pulse of current having an approximately flat top.

(22) The circuit of any one of configurations (1) through (19), wherein the energy-storage component is a first energy-storage component, the circuit further comprising a second energy-storage component to receive the forward current from the load and temporarily store the energy returned from the load prior to the second switch attaining the first state.

(23) A method of recovering energy from a load in a system that operates with repeated cycles, the method comprising: storing a first amount of energy in a first energy-storage component of a circuit; delivering, during a first portion of the first cycle of repeated cycles, at least a portion of the first amount of energy from the first energy-storage component to the load along a first circuit path of the circuit, wherein the load includes a second energy-storage component; and returning, during a second portion of the first cycle, a second amount of energy from the second energy-storage component along a second circuit path of the circuit to the first energy-storage component so that at least a portion of the returned second amount of energy is available for a first portion of a second cycle of the repeated cycles that follows the first cycle, wherein the second circuit path is different, at least in part, from the first circuit path.

(24) The method of (23), wherein: the portion of the first amount of energy is delivered to the load as a first pulse of current in response to toggling a first switch from a first state to a second state of the first switch; and the portion of the returned second amount of energy is returned to the first energy-storage component as a second pulse of current in response to toggling a second switch from a first state to a second state of the second switch.

(25) The method of (24), wherein the portion of the first amount of energy is a first portion of the first amount of energy, the method further comprising: delivering with a third switch, during the first portion of the first cycle, a second portion of the first amount of energy from the first energy-storage component to the load along a third circuit path of the circuit, wherein the second portion of the first amount of energy is delivered to the load at a higher rate of current flow than the first portion of the first amount of energy.

(26) The method of (24), further comprising: receiving, with a third energy-storage component during the first portion of the cycle, the second amount of energy from the load; and transferring, with a third switch during the second portion of the cycle, the portion of the second amount of energy to the first energy-storage component.

(27) The method of (24), further comprising: bypassing, with a third switch connected in a third circuit path, the energy storage component during the first portion of the cycle such that a peak current value circulates through at least the first switch, the load, and the third switch for an interval of time to form an approximately flat top for the first pulse of current.

(28) The method of (24) further comprising: receiving, with a third energy-storage component during the first portion of the cycle, the second amount of energy from the load; and transferring, with at least one diode during the second portion of the cycle, the portion of the second amount of energy to the first energy-storage component.

(29) The method of any one of (23) through (28), wherein delivering the portion of the first amount of energy during the first portion of the first cycle comprises flowing a current having a peak value of at least one million amps through the first switch and the method further comprises: blocking at least one thousand volts of reverse bias with the first switch during the second portion of the first cycle; and turning off the flow of current by the first switch in less than 150 microseconds before the second switch returns the second amount of energy.

(30) The method of (29), wherein the method is repeated at least 10,000 times without failure of the energy-storage component, the first switch, or the second switch.

(31) The method of any one of (23) through (30), wherein the portion of the second amount of energy is more than 90% of the portion of the first amount of energy.

(32) The method of any one of (24) through (28), wherein the delivering comprises setting the first switch to a first state such that the first switch couples the first energy-storage component to the load.

(33) The method of (32), wherein the first switch comprises at least one silicon-controlled rectifier.

(34) The method of (33), wherein the first switch further comprises a forward diode connected in series with the at least one silicon-controlled rectifier and arranged to: allow forward current flow through the at least one silicon-controlled rectifier; and block reverse current flow through the at least one silicon-controlled rectifier.

(35) The method of (33) or (34), further comprising dropping more voltage across the forward diode than across the at least one silicon-controlled rectifier when the forward diode and the at least one silicon-controlled rectifier are reversed biased.

(36) The method of any one of (33) through (35), further comprising absorbing at least 70% of a total recovery energy of the first switch with the forward diode.

(37) The method of any one of (33) through (36), wherein the first switch further comprises: a resistor connected in parallel with a silicon-controlled rectifier of the at least one silicon-controlled rectifier; and a reverse diode connected in parallel with the at least one silicon-controlled rectifier to allow reverse current flow in a parallel circuit path around a circuit path containing the at least one silicon-controlled rectifier, the parallel circuit path containing the reverse diode.

(38) The method of (37), further comprising reducing a voltage across the at least one silicon-controlled rectifier with the reverse diode when the at least one silicon-controlled rectifier is reverse biased.

(39) The method of any one of (23) through (38), wherein the delivering comprises delivering an amount of current to the load to produce a magnetic field.

(40) The method of (39), wherein the peak amount of current is from 100,000 amps to 200,000,000 amps.

(41) The method of any one of (24) through (40), wherein the returning comprises placing the second switch in a first state that couples the load to the first energy-storage component.

(42) The method of (41), wherein the second switch comprises at least one silicon-controlled rectifier.

(43) The method of any one of (23) through (42), wherein delivering the portion of the first amount of energy from the first energy-storage component to the load comprises coupling the energy to the load through at least one transformer.

(44) The method of any one of (23) through (43), further comprising:
storing a third amount of energy in a third energy-storage component; and
delivering, during the first portion of the first cycle, at least a portion of the third amount of energy from the third energy-storage component to the load along a third circuit path of the circuit, wherein the portion of the first amount of energy is delivered to a first portion of the load and the portion of the third amount of energy is delivered to a second portion of the load.

(45) A method of assembling a circuit to recover energy from a load in a system that operates with repeated cycles, the method comprising: arranging a first switch in a first circuit path to reversibly couple an energy-storage component to a load during a first portion of a first cycle of the repeated cycles, such that when the first switch is in a first state during the first portion of the first cycle, the energy-storage component delivers energy to the load along the first circuit path during the first portion of the first cycle; and arranging a second switch in a second circuit path that is different, at least in part, from the first circuit path to reversibly couple the load to the energy-storage component along the second path during a second portion of the first cycle, such that when the second switch is in a first state of the second switch during the second portion of the first cycle, energy is returned from the load to the energy-storage component during the second portion of the first cycle and made available for a first portion of a second cycle of the repeated cycles that follows the first cycle.

(46) The method of (45), further comprising assembling the first switch to include at least one silicon-controlled rectifier.

(47) The method of (46), further comprising assembling the first switch to include a forward diode connected in series with the at least one silicon-controlled rectifier and arranged to: allow forward current flow through the at least one silicon-controlled rectifier; and block reverse current flow through the at least one silicon-controlled rectifier.

(48) The method of (46) or (47), further comprising assembling the first switch to include: a resistor connected in parallel with a silicon-controlled rectifier of the at least one silicon-controlled rectifier; and a reverse diode connected in parallel with the at least one silicon-controlled rectifier to allow reverse current flow in a parallel circuit path around a circuit path containing the at least one silicon-controlled rectifier, the parallel circuit path containing the reverse diode.

(49) A system comprising: a first energy-storage component; a second energy-storage component; a load; a first switch to reversibly couple the first energy-storage component and the second energy-storage component to the load along a first circuit path during a first portion of an operational cycle of the system such that current flows from the first energy-storage component to the second energy-storage component and to the load; and a second circuit path different, at least in part, from the first circuit path and having a second switch to reversibly couple the load to the first energy-storage component during a second portion of the operational cycle, the second circuit path configured to return energy from the load to the first energy-storage component so that the returned energy is available for a start of a next operational cycle of the system and a voltage polarity across the first energy-storage component at the end of the second portion of the operational cycle is a same voltage polarity as the voltage polarity across the first energy-storage component at the beginning of the first portion of the operational cycle.

### 3. Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A circuit to deliver energy to a load in repeated cycles and recover a portion of the energy, the circuit comprising:
an energy-storage component to receive energy from a voltage source or current source;
a first switch to reversibly couple the energy-storage component to a load along a first circuit path, the first switch configured to attain a first state such that, when the first switch is in the first state during a first portion of a first cycle of the repeated cycles, forward current flows from the energy-storage component to the load; and
a second switch to reversibly couple the energy-storage component to the load along a second circuit path, wherein the second circuit path is different, at least in part, from the first circuit path, the second switch configured to attain a first state such that, when the second switch is in the first state of the second switch during a second portion of the first cycle, energy from the load is returned to the energy-storage component such that at least a portion of the energy returned is available for a first portion of a second cycle of the repeated cycles that follows the first cycle.

2. The circuit of claim 1, wherein the first switch is configured to:
switch up to one million amps of the forward current when in the first state of the first switch;
block at least 1,000 volts when in a second state in which the forward current does not flow through the first switch; and
turn off in 150 microseconds or less when transitioning between the first state of the first switch and the second state of the first switch.

3. The circuit of claim 1, wherein the circuit operates for 10,000 cycles or more without failure of the energy-storage component, the first switch, or the second switch.

4. The circuit of claim 1, wherein the energy-storage component comprises a capacitor.

5. The circuit of claim 4, wherein the capacitor has a value of capacitance in a range from 10 microfarads to 10 millifarads.

6. The circuit of claim 1, further comprising the voltage source, wherein the voltage source is of at least 1,000 volts.

7. The circuit of claim 1, further comprising the load.

8. The circuit of claim 7, wherein the energy-storage component is a first energy-storage component and the load comprises a second energy-storage component.

9. The circuit of claim 8, wherein the second energy-storage component comprises an inductor.

10. The circuit of claim 8, wherein the second energy-storage component comprises an electromagnetic coil, the electromagnetic coil being a single-turn electromagnetic coil or a segmented electromagnetic coil.

11. The circuit of claim 10, wherein the electromagnetic coil has a value of inductance in a range from 1 microhenry to 100 microhenries.

12. The circuit of claim 8, wherein the first energy-storage component comprises a first capacitor and the second energy-storage component comprises a second capacitor.

13. The circuit of claim 8, wherein the second circuit path includes a third energy-storage component.

14. The circuit of claim 13, wherein the third energy-storage component is common to the second circuit path and the first circuit path.

15. The circuit of claim 1, wherein the first switch comprises at least one silicon-controlled rectifier.

16. The circuit of claim 15, further comprising a forward diode connected in series with the at least one silicon-controlled rectifier and arranged to:
allow forward current flow through the at least one silicon-controlled rectifier; and
block reverse current flow through the at least one silicon-controlled rectifier.

17. The circuit of claim 16, wherein a first turn-off time of the forward diode between forward conduction and reverse blocking is shorter than a second turn-off time of the at least one silicon-controlled rectifier.

18. The circuit of claim 15, further comprising:
a resistor connected in parallel with a silicon-controlled rectifier of the at least one silicon-controlled rectifier; and
a reverse diode connected in parallel with the at least one silicon-controlled rectifier to allow reverse current flow in a parallel circuit path around a circuit path containing the at least one silicon-controlled rectifier, the parallel circuit path containing the reverse diode.

19. The circuit of claim 1, wherein the second switch comprises at least one silicon-controlled rectifier.

20. The circuit of claim 1, wherein the energy-storage component is a first energy-storage component, the circuit further comprising:
a second energy-storage component connected in series with the first switch; and
a third switch to reversibly couple the first energy-storage component to the load along a third circuit path, the third switch configured to attain a first state such that, when the third switch is in the first state during the first portion of a first cycle of the repeated cycles, the forward current flows from the energy-storage component to the load more rapidly through the third circuit path than through the first circuit path.

21. The circuit of claim 20, further comprising a third switch connected in a third circuit path to reversibly bypass the first energy-storage component and to circulate the forward current in a circuit loop through at least the first switch, the load, and the third switch for an interval of time to form a pulse of current having an approximately flat top.

22. The circuit of claim 1, wherein the energy-storage component is a first energy-storage component, the circuit further comprising a second energy-storage component to receive the forward current from the load and temporarily store the energy returned from the load prior to the second switch attaining the first state.

23. A method of recovering energy from a load in a system that operates with repeated cycles, the method comprising:
storing a first amount of energy in a first energy-storage component of a circuit;
delivering, during a first portion of a first cycle of the repeated cycles, at least a portion of the first amount of energy from the first energy-storage component to the load along a first circuit path of the circuit, wherein the load includes a second energy-storage component; and
returning, during a second portion of the first cycle, a second amount of energy from the second energy-storage component along a second circuit path of the circuit to the first energy-storage component so that at least a portion of the second amount of energy is available for a first portion of a second cycle of the repeated cycles that follows the first cycle, wherein the second circuit path is different, at least in part, from the first circuit path.

24. The method of claim 23, wherein:
the portion of the first amount of energy is delivered to the load as a first pulse of current in response to toggling a first switch from a first state to a second state of the first switch; and
the portion of the second amount of energy is returned to the first energy-storage component as a second pulse of current in response to toggling a second switch from a first state to a second state of the second switch.

25. The method of claim 24, wherein the portion of the first amount of energy is a first portion of the first amount of energy, the method further comprising:
delivering with a third switch, during the first portion of the first cycle, a second portion of the first amount of energy from the first energy-storage component to the load along a third circuit path of the circuit, wherein the second portion of the first amount of energy is delivered to the load at a higher rate of current flow than the first portion of the first amount of energy.

26. The method of claim 24, further comprising:
receiving, with a third energy-storage component during the first portion of the first cycle, the second amount of energy from the load; and
transferring, with a third switch during the second portion of the first cycle, the portion of the second amount of energy to the first energy-storage component.

27. The method of claim 24, further comprising:
bypassing, with a third switch connected in a third circuit path, the first energy-storage component during the first portion of the first cycle such that a peak current value circulates through at least the first switch, the load, and the third switch for an interval of time to form an approximately flat top for the first pulse of current.

28. The method of claim 24, further comprising:
receiving, with a third energy-storage component during the first portion of the first cycle, the second amount of energy from the load; and
transferring, with at least one diode during the second portion of the first cycle, the portion of the second amount of energy to the first energy-storage component.

29. The method of claim 24, wherein delivering the portion of the first amount of energy during the first portion of the first cycle comprises flowing a current having a peak value of at least one million amps through the first switch and the method further comprises:
blocking at least one thousand volts of reverse bias with the first switch during the second portion of the first cycle; and
turning off a flow of current by the first switch in less than 150 microseconds before the second switch returns the second amount of energy.

30. The method of claim 29, wherein the method is repeated at least 10,000 times without failure of the first energy-storage component, the first switch, or the second switch.

31. The method of claim 23, wherein the portion of the second amount of energy is more than 90% of the portion of the first amount of energy.

32. The method of claim 24, wherein the delivering comprises setting the first switch to a first state such that the first switch couples the first energy-storage component to the load.

33. The method of claim 32, wherein the first switch comprises at least one silicon-controlled rectifier.

34. The method of claim 33, wherein the first switch further comprises a forward diode connected in series with the at least one silicon-controlled rectifier and arranged to:
allow forward current flow through the at least one silicon-controlled rectifier; and
block reverse current flow through the at least one silicon-controlled rectifier.

35. The method of claim 3, further comprising dropping more voltage across the forward diode than across the at least one silicon-controlled rectifier when the forward diode and the at least one silicon-controlled rectifier are reversed biased.

36. The method of claim 34, further comprising absorbing at least 70% of a total recovery energy of the first switch with the forward diode.

37. The method of claim 33, wherein the first switch further comprises:
a resistor connected in parallel with a silicon-controlled rectifier of the at least one silicon-controlled rectifier; and
a reverse diode connected in parallel with the at least one silicon-controlled rectifier to allow reverse current flow in a parallel circuit path around a circuit path containing the at least one silicon-controlled rectifier, the parallel circuit path containing the reverse diode.

38. The method of claim 37, further comprising reducing a voltage across the at least one silicon-controlled rectifier with the reverse diode when the at least one silicon-controlled rectifier is reverse biased.

39. The method of claim 23, wherein the delivering comprises delivering an amount of current to the load to produce a magnetic field.

40. The method of claim 39, wherein a peak amount of current is from 100,000 amps to 200,000,000 amps.

41. The method of claim 24, wherein the returning comprises placing the second switch in a first state that couples the load to the first energy-storage component.

42. The method of claim 41, wherein the second switch comprises at least one silicon-controlled rectifier.

43. The method of claim 23, wherein delivering the portion of the first amount of energy from the first energy-storage component to the load comprises coupling the energy to the load through at least one transformer.

44. The method of claim 23, further comprising:
storing a third amount of energy in a third energy-storage component; and
delivering, during the first portion of the first cycle, at least a portion of the third amount of energy from the third energy-storage component to the load along a third circuit path of the circuit, wherein the portion of the first amount of energy is delivered to a first portion of the load and the portion of the third amount of energy is delivered to a second portion of the load.

45. A method of assembling a circuit to recover energy from a load in a system that operates with repeated cycles, the method comprising:
arranging a first switch in a first circuit path to reversibly couple an energy-storage component to a load during a first portion of a first cycle of the repeated cycles, such that when the first switch is in a first state during the first portion of the first cycle, the energy-storage component delivers energy to the load along the first circuit path during the first portion of the first cycle; and
arranging a second switch in a second circuit path that is different, at least in part, from the first circuit path to reversibly couple the load to the energy-storage component along the second circuit path during a second portion of the first cycle, such that when the second switch is in a first state of the second switch during the second portion of the first cycle, energy is returned from the load to the energy-storage component during the second portion of the first cycle and made available for a first portion of a second cycle of the repeated cycles that follows the first cycle.

46. The method of claim 45, further comprising assembling the first switch to include at least one silicon-controlled rectifier.

47. The method of claim 46, further comprising assembling the first switch to include a forward diode connected in series with the at least one silicon-controlled rectifier and arranged to:
allow forward current flow through the at least one silicon-controlled rectifier; and
block reverse current flow through the at least one silicon-controlled rectifier.

48. The method of claim 46, further comprising assembling the first switch to include:
a resistor connected in parallel with a silicon-controlled rectifier of the at least one silicon-controlled rectifier; and
a reverse diode connected in parallel with the at least one silicon-controlled rectifier to allow reverse current flow in a parallel circuit path around a circuit path containing the at least one silicon-controlled rectifier, the parallel circuit path containing the reverse diode.

49. A system comprising:
a first energy-storage component;
a second energy-storage component;
a load;
a first switch to reversibly couple the first energy-storage component and the second energy-storage component to the load along a first circuit path during a first portion of an operational cycle of the system such that current flows from the first energy-storage component to the second energy-storage component and to the load; and
a second circuit path different, at least in part, from the first circuit path and having a second switch to reversibly couple the load to the first energy-storage component during a second portion of the operational cycle, the second circuit path configured to return energy from the load to the first energy-storage component so that the energy is available for a start of a next operational cycle of the system and a voltage polarity across the first energy-storage component at an end of the second portion of the operational cycle is a same voltage polarity as the voltage polarity across the first energy-storage component at a beginning of the first portion of the operational cycle.
